(19) United States
(12) Patent Application Publication
(10) Pub. No.: US 2013/0212523 A1
(43) Pub. Date: Aug. 15, 2013

(54) INFORMATION PROCESSING APPARATUS, CONTROL METHOD OF INFORMATION PROCESSING APPARATUS, AND STORAGE MEDIUM

(71) Applicant: CANON KABUSHIKI KAISHA, (US)

(72) Inventor: Daisuke Shibata, Kawasaki-shi (JP)

(73) Assignee: CANON KABUSHIKI KAISHA, Tokyo (JP)

(21) Appl. No.: 13/712,894

(22) Filed: Dec. 12, 2012

(30) Foreign Application Priority Data
Feb. 10, 2012 (JP) 2012-027725

(51) Int. Cl. G06F 3/0482

(52) U.S. Cl. CPC G06F 3/0482
USPC 715/784

(57) ABSTRACT

An information processing apparatus of one aspect of this invention accepts a touch operation for a display area on which a list of thumbnail images corresponding to documents saved in the information processing apparatus are displayed while displaying the thumbnail images. In a case that the accepted touch operation is a flick operation in a lateral direction (first direction), the information processing apparatus changes a thumbnail image displayed in an area for which the flick operation has been made to that of a different page included in a corresponding document. In a case that the accepted touch operation is a flick operation in a longitudinal direction (second direction), the information processing apparatus scrolls a plurality of thumbnail images displayed in the list on the display area in the direction of the flick operation.

### BACKGROUND OF THE INVENTION

1. Field of the Invention

The present invention relates to an information processing apparatus for retrieving an electronic document, a control method of the information processing apparatus, and a storage medium.

2. Description of the Related Art

As a technique for retrieving a specific document from a plurality of documents stored in an information processing apparatus such as a personal computer (PC), a technique for displaying a reduced-scale image of a top page of each document as a thumbnail image is known. According to this technique, the user can judge the contents of respective documents based on the displayed thumbnail images. In this case, the number of thumbnail images simultaneously displayable in a display area of a display device included in the information processing apparatus is limited according to the size of the display area. For this reason, when a large number of documents are stored in the information processing apparatus, the user has to retrieve a specific document while switching documents to be displayed by means of thumbnail images as needed. Since the user cannot recognize the contents of each document based only on the thumbnail images of the top pages of the documents, he or she has to further confirm the contents.

In order to solve such problem, Japanese Patent Laid-Open No. 6-168276 has proposed a technique for switching a display page of thumbnail image data to an arbitrary page. Also, Japanese Patent Laid-Open No. 2011-221790 has proposed a technique for changing a layout state of a plurality of objects when an operation input in a second direction is detected for the plurality of objects in the layout state in which objects are laid out in a first direction. In this manner, the user can confirm the contents of a plurality of specific objects.

However, in Japanese Patent Laid-Open No. 6-168276, in order to switch thumbnail image data of a page of a document file displayed on a screen to that of another page, the user has to select the document file first, and then input its change instruction. Furthermore, in order to retrieve a desired file from a large number of document files with reference to thumbnail image data, the user has to frequently make such page switching operation on the screen on which a list of thumbnail image data is displayed.

Also, in Japanese Patent Laid-Open No. 2011-221790, in order to display information associated with a plurality of objects, after the layout state itself of the plurality of objects is changed, the associated information has to be displayed. Such change in layout state (display screen) bothers the user, and results in poor operability for the user.

### SUMMARY OF THE INVENTION

The present invention has been made in consideration of the aforementioned problems. The present invention provides a technique for scrolling a displayed list and switching thumbnail images by simpler operations upon displaying a list of thumbnail images corresponding to documents saved in an information processing apparatus.

According to one aspect of the present invention, there is provided an information processing apparatus, which comprises a display unit configured to display a list of thumbnail images corresponding to documents saved in the information processing apparatus, comprising: a display control unit configured to lay out a plurality of thumbnail images each of which is a thumbnail image of an arbitrary page included in a corresponding document, and to display a list of the plurality of thumbnail images on the display unit; an accepting unit configured to accept a touch operation for a display area of the display unit on which the list of the plurality of thumbnail images is displayed; a thumbnail changing unit configured to change, in a case that the touch operation accepted by the accepting unit is a flick operation in a first direction, a thumbnail image displayed on an area for which the flick operation has been made on the display area, of the plurality of thumbnail images, to a thumbnail image of a different page included in a corresponding document; and a scrolling unit configured to scroll, in a case that the touch operation accepted by the accepting unit is a flick operation in a second direction perpendicular to the first direction, the list of the plurality of thumbnail images displayed on the display area in the second direction.

According to another aspect of the present invention, there is provided an information processing apparatus, which comprises a display unit configured to display a list of thumbnail images corresponding to documents saved in the information processing apparatus, comprising: a display control unit configured to lay out a plurality of thumbnail images each of which is a thumbnail image of an arbitrary page included in a corresponding document, and to display a list of the plurality of thumbnail images on the display unit; an accepting unit configured to accept a touch operation for a display area of the display unit on which the list of the plurality of thumbnail images is displayed; a thumbnail changing unit configured to change, in a case that the touch operation accepted by the accepting unit is a flick operation for an area on which one thumbnail image is displayed on the display area, the one thumbnail image to a thumbnail image of a different page included in a corresponding document; and a scrolling unit configured to scroll, in a case that the touch operation accepted by the accepting unit is a flick operation across areas on which two or more thumbnail images that are laid out at neighboring positions are displayed on the display area, the list of the plurality of thumbnail images displayed on the display area in a direction of the flick operation.

According to still another aspect of the present invention, there is provided a method for controlling an information processing apparatus, which comprises a display unit configured to display a list of thumbnail images corresponding to documents saved in the information processing apparatus, comprising: laying out a plurality of thumbnail images each of which is a thumbnail image of an arbitrary page included in a corresponding document, and displaying a list of the plurality of thumbnail images on the display unit; accepting a touch operation for a display area of the display unit on which the list of the plurality of thumbnail images is displayed; changing, in a case that the touch operation accepted in the accepting is a flick operation in a first direction, a thumbnail image displayed on an area for which the flick operation has been made on the display area, of the plurality of thumbnail images, to a thumbnail image of a different page included in a corresponding document; and scrolling, in a case that the touch operation accepted in the accepting is a flick operation in a second direction perpendicular to the first direction, the list of the plurality of thumbnail images displayed on the display area in the second direction.

According to yet another aspect of the present invention, there is provided a method for controlling an information processing apparatus, which comprises a display unit configured to display a list of thumbnail images corresponding to documents saved in the information processing apparatus, comprising: laying out a plurality of thumbnail images each of which is a thumbnail image of an arbitrary page included in a corresponding document, and displaying a list of the plurality of thumbnail images on the display unit; accepting a touch operation for a display area of the display unit on which the list of the plurality of thumbnail images are displayed; changing, in a case that the touch operation accepted in the accepting is a flick operation for an area on which one thumbnail image is displayed on the display area, the one thumbnail image to a thumbnail image of a different page included in a corresponding document; and scrolling, in a case that the touch operation accepted in the accepting is a flick operation across areas on which two or more thumbnail images that are laid out at neighboring positions are displayed on the display area, the list of the plurality of thumbnail images displayed on the display area in a direction of the flick operation.

According to the present invention, a technique for scrolling a list display and switching thumbnail images by simpler operations upon displaying a list of thumbnail images corresponding to documents saved in an information processing apparatus can be provided. With this technique, the user can efficiently retrieve a desired document file from document files saved in the information processing apparatus.

Further features of the present invention will become apparent from the following description of exemplary embodiments (with reference to the attached drawings).

### BRIEF DESCRIPTION OF THE DRAWINGS

FIG. 1 is a block diagram showing the hardware arrangement of an information processing apparatus 100 according to the first embodiment;

FIG. 2 is a block diagram showing the functional arrangement of the information processing apparatus 100 according to the first embodiment;

FIG. 3 is a view showing an example of a document list display screen to be displayed on a display unit 111 according to the first embodiment;

FIGS. 4A, 4B, and 4C are views showing the relationship between a list display area 307 and document list buffer according to the first embodiment;

FIGS. 5A, 5B, and 5C are views showing an example of transition of a display screen corresponding to a lateral flick operation for one block in the list display area 307 according to the first embodiment;

FIGS. 6A, 6B, and 6C are views showing an example of transition of a display screen corresponding to a longitudinal flick operation for the list display area 307 according to the first embodiment;

FIGS. 7A, 7B, and 7C are views showing an example of transition of a display screen corresponding to a lateral flick operation for a plurality of blocks in the list display area 307 according to the first embodiment;

FIG. 8 is a flowchart showing the list display control sequence of thumbnail images in the information processing apparatus 100 according to the first embodiment;

FIG. 9 is a flowchart showing the sequence of thumbnail image changing processing in the information processing apparatus 100 according to the first embodiment;

FIGS. 10A and 10B are flowcharts showing the sequence of thumbnail list display scrolling processing in the information processing apparatus 100 according to the first embodiment;

FIGS. 11A, 11B, and 11C are views showing an example of transition of a display screen corresponding to a flick operation for one block in the list display area 307 according to the second embodiment;

FIGS. 12A, 12B, and 12C are views showing an example of transition of a display screen corresponding to a flick operation across a plurality of blocks in the list display area 307 according to the second embodiment;

FIGS. 13A, 13B, and 13C are views showing an example of transition of a display screen corresponding to a flick operation across a plurality of blocks in the list display area 307 according to the second embodiment;

FIGS. 14A, 14B, and 14C are views showing an example of transition of a display screen corresponding to a flick operation across a plurality of blocks in the list display area 307 according to the second embodiment;

FIGS. 15A and 15B are views showing determination processing in a flick operation in one block according to the second embodiment;

FIG. 16 is a view showing an example of a document list buffer according to the second embodiment;

FIG. 17 is a flowchart showing the list display control sequence of thumbnail images in the information processing apparatus 100 according to the second embodiment;

FIG. 18 is a flowchart showing the sequence of thumbnail image changing processing in the information processing apparatus 100 according to the second embodiment;

FIGS. 19A and 19B are flowcharts showing the sequence of thumbnail list display scrolling processing in the information processing apparatus 100 according to the second embodiment;

FIG. 20 is a view showing an example of a page list display screen to be displayed on the display unit 111 according to the third embodiment;

FIG. 21 is a flowchart showing the list display control sequence of thumbnail images in the information processing apparatus 100 according to the third embodiment; and

FIG. 22 is a flowchart showing the sequence of page list display processing in the information processing apparatus 100 according to the third embodiment.

### DESCRIPTION OF THE EMBODIMENTS

Hereinafter, embodiments of the present invention will be described in detail with reference to the accompanying drawings. It should be noted that the following embodiments are not intended to limit the scope of the appended claims, and that not all the combinations of features described in the embodiments are necessarily essential to the solving means of the present invention.

### First Embodiment

The first embodiment will explain a case in which the present invention is applied to an information processing apparatus such as a personal computer (PC) or mobile terminal as an example of an information processing apparatus of the present invention. However, the information processing apparatus of the present invention may be, for example, an MFP (Multi Function Peripheral) which can save print target files, files generated by scan processing, and the like.

<Hardware Arrangement of Information Processing Apparatus 100>

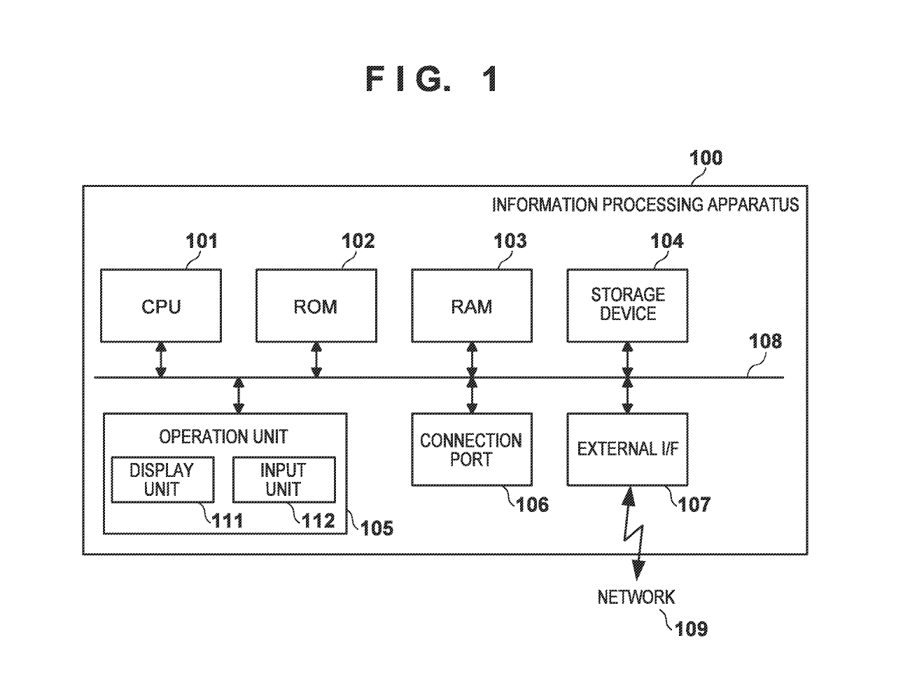

The hardware arrangement of an information processing apparatus 100 according to this embodiment will be described below with reference to FIG. 1. As shown in FIG. 1, the information processing apparatus 100 includes a CPU 101, ROM 102, RAM 103, storage device 104, operation unit 105, connection port 106, and external I/F 107, which are connected to each other via a bus 108.

The CPU 101 functions as an arithmetic processing device and control device, and controls the overall information processing apparatus 100 by reading out and executing control programs stored in the ROM 102 and storage device 104. The ROM 102 stores, for example, information such as control programs required to execute processes according to flowcharts (to be described later). The RAM 103 is used as temporary storage areas such as a main memory and a work area of the CPU 101. The storage device 104 stores information such as control programs as in the ROM 102, and various electronic files such as document files and image files. The storage device 104 is, for example, a hard disk drive (HDD).

The operation unit 105 includes a display unit 111 and input unit 112. The display unit 111 includes a display device (display) such as a liquid crystal display (LCD). The display unit 111 displays various kinds of information, operation screens, and the like in the information processing apparatus 100. The input unit 112 includes input devices such as a touch panel, keyboard (hardware keys), and the like. The touch panel of the input unit 112 is arranged on a surface of the display unit 111.

The display unit 111 displays information required for operations as an operation screen under the control of the CPU 101 when the user operates the touch panel of the input unit 112 (touch operation). The user operates the touch panel to input instructions via the operation screen displayed on the display unit 111. When the input unit 112 accepts an input (operation) by the user via the touch panel, it transmits a signal corresponding to the input (operation) to the CPU 101.

Note that the user touches (makes a touch operation) the surface of the touch panel with the finger. In this embodiment, when the user touches the touch panel with the finger, this operation will often be described as a touch operation on the display surface of the display unit 111. When the operation unit 105 accepts a touch operation on the touch panel, this operation will often be described as that accepted for an element on an area (position) where the touch operation is made, which element is included in the screen displayed on the display unit 111. As the touch panel, any of touch panels of various types such as a resistive type, capacitance type, surface acoustic wave type, infrared type, electromagnetic induction type, image recognition type, and optical sensor type may be used.

The connection port 106 is an interface to which an external device is connected, and is, for example, a port to which an external device that can exchange data via USB (Universal Serial Bus) is connected. The external interface (I/F) 107 is a communication device required to communicate with an external apparatus connected via a network 109, and functions as an external communication interface. The external I/F 107 executes input/output control required to output information to an external apparatus or to accept information input from an external apparatus via the network 109. Note that the external I/F 107 may be a communication device which performs wireless communications supporting a wireless local area network (LAN) or short-range wireless communication or a communication device which performs wired communications.

<Functional Arrangement of Information Processing Apparatus 100>

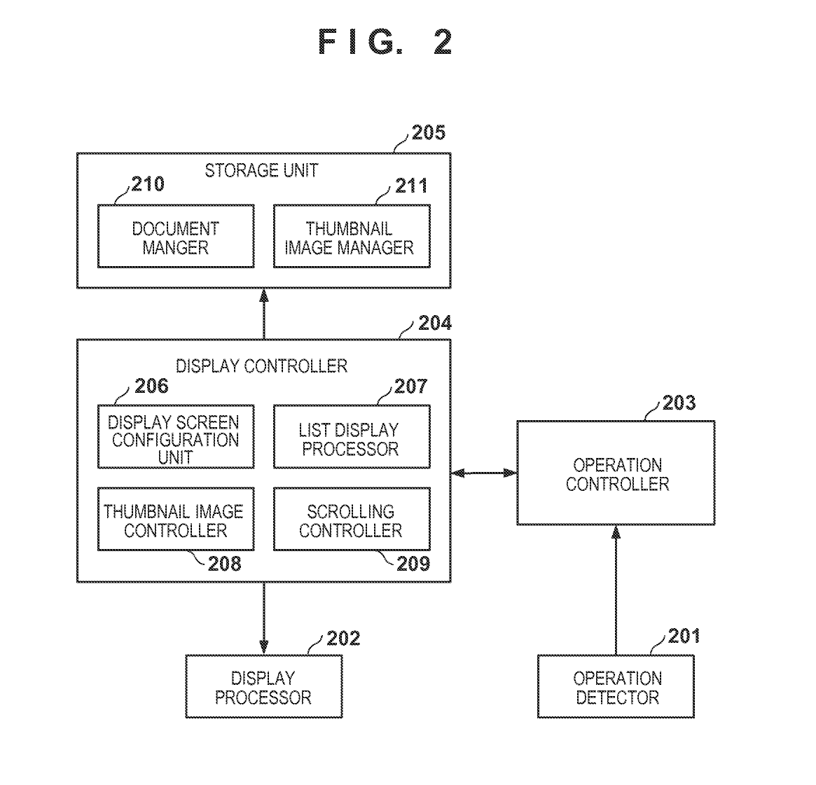

The functional arrangement of the information processing apparatus 100 will be described below with reference to FIG. 2. Functions of respective blocks (functional units) shown in FIG. 2 may be implemented by dedicated hardware components or by software (programs) in the information processing apparatus 100. In this embodiment, assume that the functions of the respective functional units shown in FIG. 2 are implemented on the information processing apparatus 100 when the CPU 101 reads out control programs stored in the ROM 102 or storage device 104 onto the RAM 103 and executes the readout programs. That is, the respective functional units shown in FIG. 2 run on the CPU 101, and hence, the functions of the respective functional units are executed by the CPU 101.

The information processing apparatus 100 includes an operation detector 201, display processor 202, operation controller 203, display controller 204, and storage unit 205 as functional units which execute the corresponding functions.

The CPU 101 receives a signal corresponding to an input via the input unit 112, which input is transmitted from the operation unit 105. More specifically, the operation detector 201 which runs on the CPU 101 receives the signal from the operation unit 105. Upon reception of the signal corresponding to the input via the input unit 112, the operation detector 201 converts the received signal into corresponding operation input information, and outputs the converted information to the operation controller 203. Note that the operation controller 203 provides operation information generated by interpreting the operation input information input from the operation detector 201 to the display controller 204.

The display processor 202 executes processing for displaying information on the display unit 111. The display processor 202 generates information (screen information) indicating a screen to be displayed on the display unit 111, and transfers the screen information to the operation unit 105 as an output signal from the CPU 101. Upon reception of display contents to be displayed on the display unit 111 from the display controller 204, the display processor 202 generates screen information corresponding to the display contents, and transmits the generated information to the operation unit 105.

The operation controller 203 generates operation information including action information and position information based on the operation input information received from the operation detector 201, and screen configuration information and layout information obtained from the display controller 204. The operation controller 203 provides the generated operation information to the display controller 204.

The display controller 204 includes a display screen configuration unit 206, list display processor 207, thumbnail image controller 208, and scrolling controller 209.

The display screen configuration unit 206 configures (generates) a screen to be displayed on the display unit 111 by judging the display contents on the display unit 111 based on the operation information obtained from the operation controller 203 or based on the display contents. The display screen configuration unit 206 transfers information indicating the contents of the generated screen to the display processor 202.

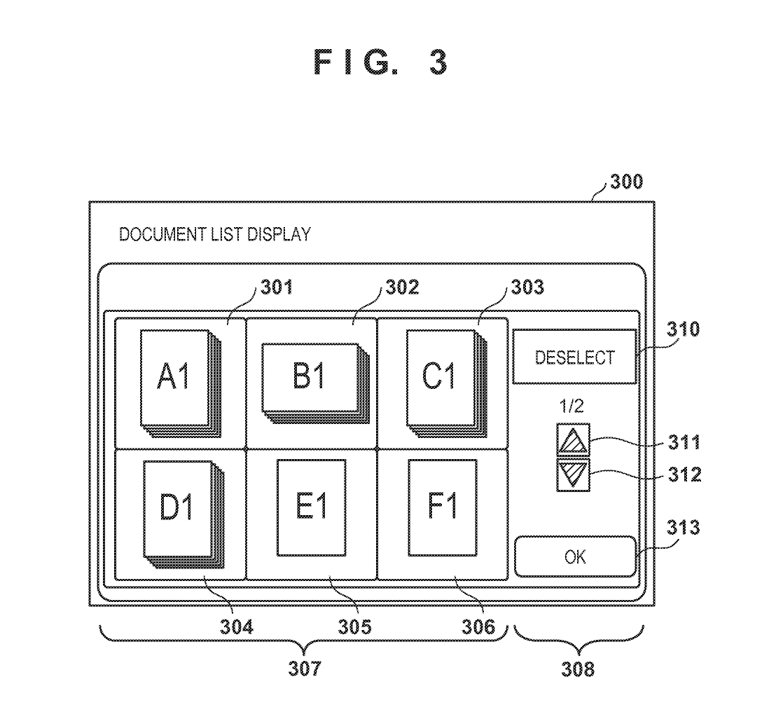

The list display processor 207 generates a document list buffer, and controls areas (display positions) whose corresponding images are to be displayed in a list, among a plurality of areas in which image data are respectively stored. The document list buffer is a buffer on the RAM 103, which is used for preparation of displaying, on the display unit 111, information (thumbnail images) associated with documents saved and managed by the information processing apparatus 100. The list display processor 207 assures, as the document list buffer on the RAM 103, a storage area of a predetermined size, which corresponds to a list display area required to display a list of information associated with document, in the display area of the display unit 111. (This list display area corresponds to a list display area 307 shown in FIG. 3.) The list display buffer is divided into a plurality of (storage) areas, and any of documents saved and managed by the information processing apparatus 100 is associated with each of the divided areas.

The thumbnail image controller 208 reads out a thumbnail image of a designated page in a designated document from the storage device 104 or the like via a thumbnail image manager 211 in accordance with an instruction from the list display processor 207. Furthermore, the thumbnail image controller 208 loads thumbnail images of designated pages of associated documents in the respective areas in the document list buffer in accordance with an instruction from the list display processor 207.

The scrolling controller 209 controls scrolling of a displayed part of the list display area of documents in accordance with an instruction from the list display processor 207.

The storage unit 205 has a document manager 210 and the thumbnail image manager 211. The document manager 210 manages document files stored in the storage device 104 or the like in the information processing apparatus 100, and management information (a management number, document class, name, document size, file size, page count, date/time, selection state, etc.) of each document file. Furthermore, the document manager 210 sorts the document files based on the management information.

The thumbnail image manager 211 generates thumbnail images corresponding to respective documents from those saved in the information processing apparatus 100, and manages the generated thumbnail images. As for a document, a thumbnail image of which cannot be generated, the thumbnail image manager 211 generates an alternative image of the thumbnail image. The thumbnail image manager 211 manages the generated thumbnail images or alternative images in association with documents. Note that the thumbnail image manager 211 manages image data corresponding to the generated thumbnail images or alternative images in a state in which they are saved in the storage device 104 or the like.

<Gesture Operation at Operation Unit 105>

Gesture operations accepted via the operation unit 105 and determination processing of the gesture operations to be executed by the operation controller 203 will be described below. When the user makes a touch operation on the touch panel of the input unit 112, the operation controller 203 accepts that touch operation as a gesture operation as follows.

In order to accept a gesture operation by the user, when an input pointer corresponding to a position touched by the user's finger on the touch panel of the input unit 112 has moved, the operation unit 105 notifies the operation controller 203 of a locus of that input pointer. More specifically, the operation unit 105 notifies the CPU 101 of information indicating coordinates of the input pointer on the display area of the display unit 111 at given time intervals. The operation controller 203 which runs on the CPU 101 can acquire the information indicating the coordinates of the input pointer, which is notified from the operation unit 105, and temporarily stores the acquired information on the RAM 103. The operation controller 203 converts the coordinates of the input pointer into a vector based on pieces of information stored in the RAM 103 within a predetermined period, thereby generating information indicating a locus of the input pointer. The operation controller 203 determines whether or not a locus corresponding to a predetermined gesture operation matches that of the input pointer, thereby determining a gesture operation accepted via the operation unit 105.

In general, the gesture operations include those called “tap”, “double-tap”, “drag”, “flick”, and “hold”. “Tap” is an operation for lightly tapping (touching) the touch panel with the finger, and corresponds to clicking of a mouse. “Double-tap” is an operation for successively making “tap” twice, and corresponds to double-clicking of the mouse. “Drag” is an operation for shifting the tapping finger (moving the position of the finger while the finger is kept touched on the touch panel). “Flick” is an operation for moving the finger touched on the touch panel to lightly sweep on the touch panel. “Hold” is an operation attained when the finger is kept touched on the touch panel. Note that the gesture operations my be made using a pen or the like in place of the user's finger.

In this embodiment, the operation controller 203 determines an operation made by the user at the operation unit 105 (a touch operation made on the touch panel of the input unit 112) based on the information notified from the operation unit 105. The operation controller 203 associates the aforementioned respective gesture operations with operation information to be notified to the display controller 204 so as to notify the display controller 204 of operation information corresponding to the gesture operation. For example, when the operation controller 203 determines that a tap operation is accepted, it notifies the display controller 204 of operation information indicating a selection operation for coordinates where that operation was made. Also, when the operation controller 203 determines that a double-tap operation is accepted, it notifies the display controller 204 of operation information indicates a decision operation for the coordinate where that operation was made. Note that the gesture operations and operation information can be associated with each other in association with operations required to control the information processing apparatus 100.

<Example of Document List Display Screen>

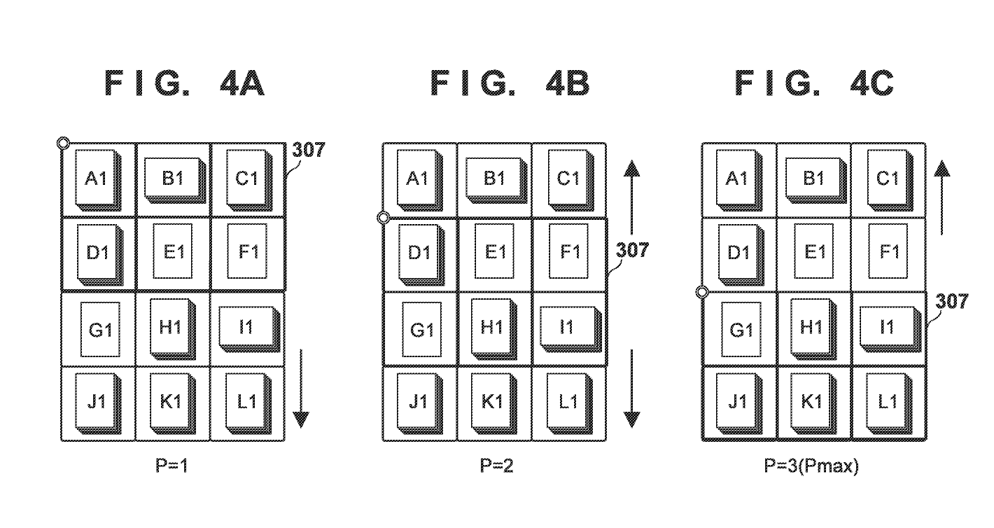

An example of a document list display screen to be displayed on the display unit 111 and operation examples via this screen in the information processing apparatus 100 according to this embodiment will be described below with reference to FIG. 3 and FIGS. 4A to 4C. The information processing apparatus 100 displays a list of documents by displaying a list of thumbnail images corresponding to documents (electronic documents) saved in the information processing apparatus on the display unit 111 (the list display area 307 thereof).

When the information processing apparatus 100 accepts a display instruction of a list display screen required to display a list of documents from the user via the operation unit 105, it displays a list display screen 300 shown in FIG. 3. The list display screen 300 is a screen used to display a list of document files (documents) stored in the storage device 104 or the like of the information processing apparatus 100, and to accept selection of a desired document file (document) from the user. As shown in FIG. 3, the list display screen 300 includes the list display area 307 on which a list of documents are displayed, and an area 308 where various software buttons 310 to 313 required to operate the display screen are displayed.

On the list display area 307, pieces of information associated with documents are displayed. On the list display area 307, images are displayed based on image data stored in areas, of the plurality of areas in the document list buffer, corresponding to designated display positions. The list display area 307 is divided into N grid-like blocks 301 to 306, and one document is displayed within each divided block. That is, the list display area 307 displays pieces of information associated with a total of N documents. Letting NX be the number of divisions in the lateral direction and NY be the number of divisions in the longitudinal direction in the list display area 307, the number N of blocks in the list display area 307 is calculated by N=NX×NY.

The N (N=6 in this case) blocks 301 to 306 have one-to-one correspondence with N documents. When designation of documents to be displayed within the list display area 307 is changed, association between N documents to be newly displayed and the N blocks 301 to 306 is changed.

The document list buffer is used to prepare for images to be displayed in a document list. As described above, the document list buffer includes a plurality of divided areas, and each area stores image data of a thumbnail image of a corresponding document. An image obtained by laying out thumbnail images associated with the predetermined number of documents can be generated from image data of thumbnail images stored in the plurality of areas in the document list buffer. Of the entire generated image, a part corresponding to the list display area 307 is displayed as the document list display screen, as shown in FIG. 3. That is, of the plurality of areas in the document list buffer, thumbnail images in the areas corresponding to the list display area 307 are displayed in the blocks 301 to 306, and those of the remaining areas are not displayed.

The document list buffer is generated based on a size (the number N of blocks) of the list display area 307, that is, the numbers NX and NY of divisions. The document list buffer is required to include at least N areas equal to the number of thumbnail images displayed on the list display area 307. A size (the number of areas included in the buffer) of the document list buffer is desired to be an integer multiple of N, but it may be set to be an arbitrary size in correspondence with the capacity of the RAM 103 or in correspondence with the total number of documents managed by the document manager 210.

The contents displayed on the list display area 307 are decided by designating a display position P in the document list buffer. Note that the display position P indicates a list display target area of a thumbnail image in the list display area 307 of the plurality of areas in the document list buffer. In this embodiment, the display position P is expressed as 1≦P≦Pmax. In this embodiment, the display position P can identify an area which stores image data of a thumbnail image to be displayed in the block 301 of the longitudinal areas (row) in the document list buffer, and can designate an arbitrary position between a start part to an end part of the document list buffer.

In the respective areas in the document list buffer, thumbnail images of corresponding documents are laid out, and image data of these thumbnail images are stored. In this embodiment, thumbnail images which are displayed on the list display screen 300 in an initial state, and are laid out in the respective areas of the document list buffer, are those of top pages of corresponding documents.

The relationship between the document list buffer and the list display area 307 will be described below with reference to FIGS. 4A to 4C. In this case, the numbers NX and NY of divisions in the lateral and longitudinal directions in the list display area 307 are respectively NX=3 and NY=2, that is, N=6, as shown in FIG. 3 and FIGS. 4A to 4C. On the other hand, as shown in FIGS. 4A to 4C, the document list buffer includes a plurality of areas divided into four rows three columns. For this reason, the number of documents to be associated with the respective areas of the document list buffer (to lay out their thumbnail images) is 12. In the document list buffer, documents having management numbers 1 to 3 are assigned to the areas in turn from the upper left area (row 1, column 1) in the horizontal direction (row direction), and documents having management numbers 4 to 6 are assigned to the areas in turn in the next row. The same applies to the remaining rows.

FIGS. 4A, 4B, and 4C respectively show cases when the display position P is a start position (P=1), in an intermediate state (P=2), and at an end position (P=3). As shown in FIGS. 4A to 4C, the list display area 307 displays thumbnail images of documents corresponding to areas included in a range identified according to the display position P of those of documents corresponding to the respective areas in the document list buffer. A list of the thumbnail images laid out within the range identified according to the display position P in the document list buffer is displayed while being laid out in the blocks 301 to 306 in the list display area 307.

The user can press (make a touch operation to) one of the blocks 301 to 306 on the touch panel of the input unit 112 while a list of thumbnail images is displayed on the list display area 307. Thus, the user can select or deselect a document corresponding to the thumbnail image displayed in the touched block (area). According to operation information indicating such select or deselect operation, the display controller 204 executes control to switch between display indicating a select state and display indicating a deselect state for the blocks 301 to 306 as touch operation targets.

<Operation Example via List Display Screen 300>

Operations from the user via the list display screen 300 will be described below with reference to FIG. 3 and FIGS. 4A to 4C again. Referring to FIG. 3, the user is allowed to make a select operation for the blocks 301 to 306 in the list display area 307. When the CPU 101 accepts selection of any of the blocks 301 to 306, it changes documents corresponding to the selected blocks to a select state. Even if the CPU 101 accepts selection of a plurality of blocks of the blocks 301 to 306, it sets a plurality of corresponding documents in a select state. When the display position P in the document list buffer is changed, the CPU 101 maintains the select state of the documents. When a document already in the select state is selected via the blocks 301 to 306 (when a deselect operation is made), the CPU 101 cancels the select state of that document.

When one or more documents are selected, the CPU 101 enables a select operation for the deselect button 310 and OK button 313. On the other hand, when none of documents are selected, the CPU 101 disables a select operation for the deselect button 310 and OK button 313. When the user presses (makes a touch operation of) the deselect button 310, the CPU 101 cancels the select state of all the documents. When the user presses (makes a touch operation of) the OK button 313, the CPU 101 begins to execute a function designated by the user for documents already set in the select state, and ends the display operation of the list display screen 300.

A display back button 311 and display advance button 312 are used to instruct to increase or decrease the display position P in the document list buffer according to a prescribed change count M. Changes of the display position P corresponding to the display back button 311 and display advance button 312 will be described below with reference to FIGS. 4A to 4C. Assume that the prescribed change count M=1.

Referring to FIG. 4A, when the CPU 101 accepts an operation of the display back button 311, it invalidates that operation. When the CPU 101 accepts an operation of the display advance button 312, it adds M to P to set P=2. Thus, the display state of the list display area 307 is changed from that of FIG. 4A (start position display) to that of FIG. 4B (intermediate position display).

Referring to FIG. 4B, when the CPU 101 accepts an operation of the display back button 311, it subtracts M from P to set P=1. Thus, the display state of the list display area 307 is changed from that of FIG. 4B to that of FIG. 4A. On the other hand, when the CPU 101 accepts an operation of the display advance button 312, it adds M to P to set P=3. Thus, the display state of the list display area 307 is changed from that of FIG. 4B to that of FIG. 4C (end position display).

Referring to FIG. 4C, when the CPU 101 accepts an operation of the display advance button 311, it invalidates that operation. When the CPU 101 accepts an operation of the display back button 312, it subtracts M from P to set P=2. Thus, the display state of the list display area 307 is changed from that of FIG. 4C to that of FIG. 4B.

Each of the plurality of areas (blocks 301 to 306) included in the list display area 307 shown in FIG. 3 and FIGS. 4A to 4C displays a thumbnail image according to the contents of a corresponding document. For example, in FIG. 3, since a document corresponding to the block 301 is an A4-size document, a thumbnail image having an aspect ratio which matches that size is displayed in the block 301. Since this document includes 10 pages, an image indicating a state in which a plurality of pages are overlaid is displayed. This informs the user that the corresponding document includes a plurality of pages.

In this embodiment, when the number of pages of a document corresponding to each block is less than the predetermined number of pages, an image indicating a state in which pages as many as that number of pages are overlaid is displayed. When the number of pages of that document is equal to or larger than the predetermined number of pages, an image indicating a state in which pages as many as the specific number of pages are overlaid is displayed. Note that a layout of thumbnail images to be displayed on the list display area 307 can be arbitrarily determined. The numbers NX and NY of divisions can be determined in correspondence with, for example, the size of the list display area 307. Alternatively, in accordance with the numbers NX and NY of divisions, a size of each thumbnail image to be displayed on the list display area 307 may be dynamically changed. Also, the prescribed change count M is not limited to M=1, and can be set to be an arbitrary value.

<Screen Control in response to Gesture Operation>

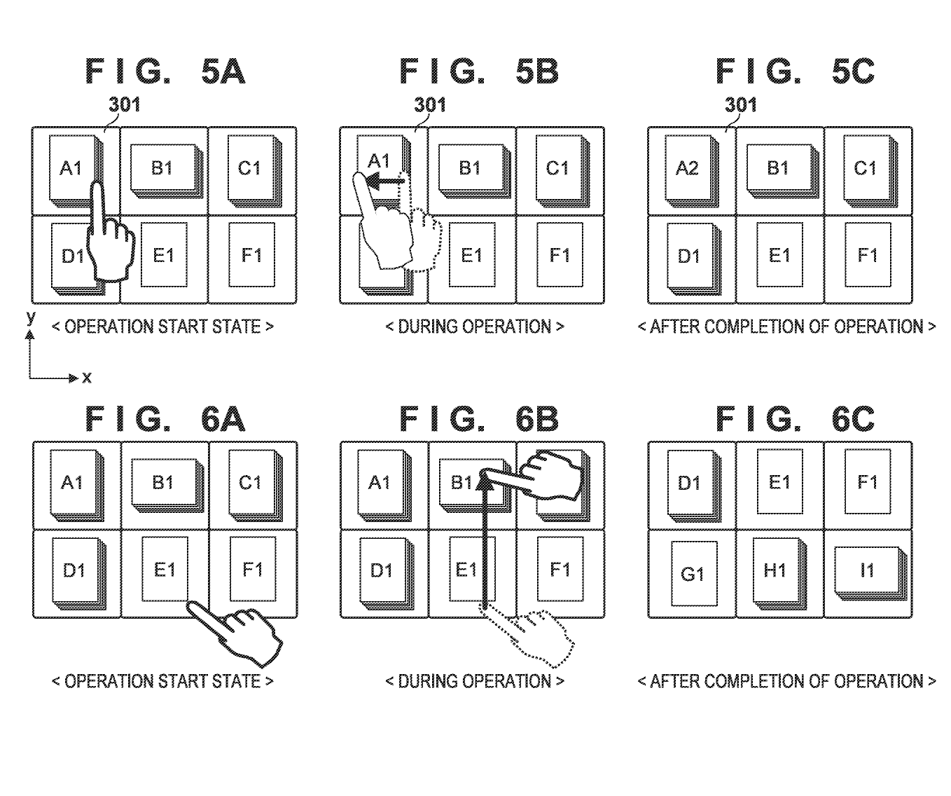

Transition of a display screen in the list display area 307 and processing of the respective functional units upon acceptance of gesture operations for the list display area 307 of the list display screen 300 at the operation unit 105 will be described below with reference to FIGS. 5A to 7C.

A case will be described first with reference to FIGS. 5A to 5C wherein a flick operation in a lateral direction (horizontal direction, X direction) is accepted as a gesture operation for any one of the blocks 301 to 306 in the list display area 307. As shown in FIG. 5A, the user touches a position (area) corresponding to any one (block 301) of the blocks 301 to 306 on the touch panel of the input unit 112. Furthermore, the user makes a flick operation in the lateral direction in that block to have the touched position as a start point, as shown in FIG. 5B. That is, the user makes a flick operation for the area (block) on which one thumbnail image is displayed.

Upon determining that such flick operation is accepted, the operation controller 203 instructs the display controller 204 to change a thumbnail image for a document corresponding to the block for which the operation has been made. The thumbnail image controller 208 in the display controller 204 executes changing processing of a thumbnail image displayed on the block as the flick operation target in accordance with the instruction from the operation controller 203. More specifically, as shown in FIG. 5C, the thumbnail image controller 208 changes a thumbnail image displayed on the block 301 as the flick operation target from a thumbnail image A1 of the top page to a thumbnail image A2 of the next page. In this way, the thumbnail image controller 208 changes a thumbnail image displayed on the area (block 301) for which the flick operation has been made to that of a different page (in this case, the next page) included in the corresponding document.

A case will be described below with reference to FIGS. 6A to 6C wherein a flick operation in a longitudinal direction (vertical direction) with respect to the list display area 307 is accepted as a gesture operation. As shown in FIG. 6A, the user touches an arbitrary position corresponding to the blocks 301 to 306 in the list display area 307 on the touch panel of the input unit 112. Furthermore, as shown in FIG. 6B, the user makes a flick operation in the longitudinal direction (vertical direction, Y direction) to have the touched position as a start point.

Upon determining that such flick operation is accepted, the operation controller 203 instructs the display controller 204 to change the display position P in the document list buffer by scrolling processing of the display contents (list display of thumbnail images) in the list display area 307. In the display controller 204, the list display processor 207 changes the display position P along the direction of the flick operation, and instructs the scrolling controller 209 to execute scrolling processing based on the changed display position P in accordance with the instruction from the operation controller 203. The scrolling controller 209 executes the scrolling processing of the display contents so that the display contents in the list display area 307 change to those corresponding to the display position P in accordance with the instruction. As a result, the display contents in the list display area 307 are changed from those shown in FIG. 6A to those shown in FIG. 6C. In this manner, the scrolling controller 209 scrolls a plurality of thumbnail images displayed in the list display area 307 in the direction of the flick operation according to the flick operation in the longitudinal direction.

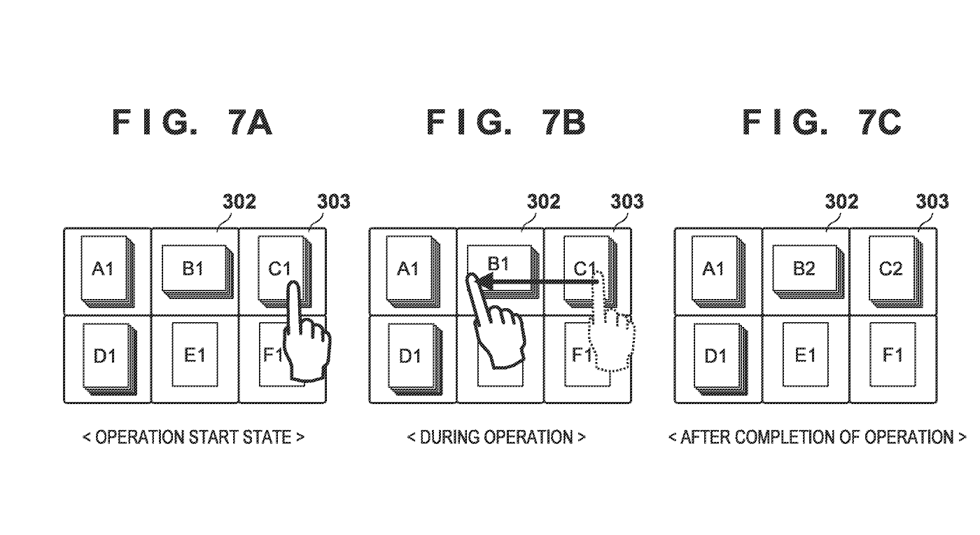

A case will be described with reference to FIGS. 7A to 7C wherein a flick operation in the lateral direction for a plurality of blocks of the blocks 301 to 306 in the list display area 307 is accepted as a gesture operation. As shown in FIG. 7A, the user touches a position corresponding to any one (block 303) of the blocks 301 to 306 on the touch panel of the input unit 112. Furthermore, as shown in FIG. 7B, the user makes a flick operation in the lateral direction across a plurality of neighboring blocks (from the block 303 to the block 302) to have the touched position as a start point. More specifically, the user makes a flick operation across areas (blocks) in which two or more neighboring thumbnail images are laid out and displayed.

Upon determining that such flick operation is accepted, the operation controller 203 instructs the display controller 204 to change thumbnail images for documents corresponding to all the blocks for which that operation has been made. The thumbnail image controller 208 in the display controller 204 executes changing processing of thumbnail images displayed on all the blocks (blocks 303 and 302) as flick operation targets in accordance with the instruction from the operation controller 203. More specifically, as shown in FIG. 7C, the thumbnail image controller 208 changes thumbnail images displayed on the blocks 303 and 302 as the flick operation targets from thumbnail images C1 and B1 on the top page to thumbnail images C2 and B2 on the next page. In this manner, the thumbnail image controller 208 changes all of two or more thumbnail images which are displayed on the areas (blocks) as flick operation targets and are laid out at neighboring positions to those on a different page included in the corresponding document.

In this embodiment, the flick operation in the lateral direction for the list display area 307 is an example of that in a first direction. The flick operation in the longitudinal direction for the list display area 307 is an example of that in a second direction perpendicular to the first direction.

<Control Sequence of Thumbnail List Display Corresponding to Gesture Operation>

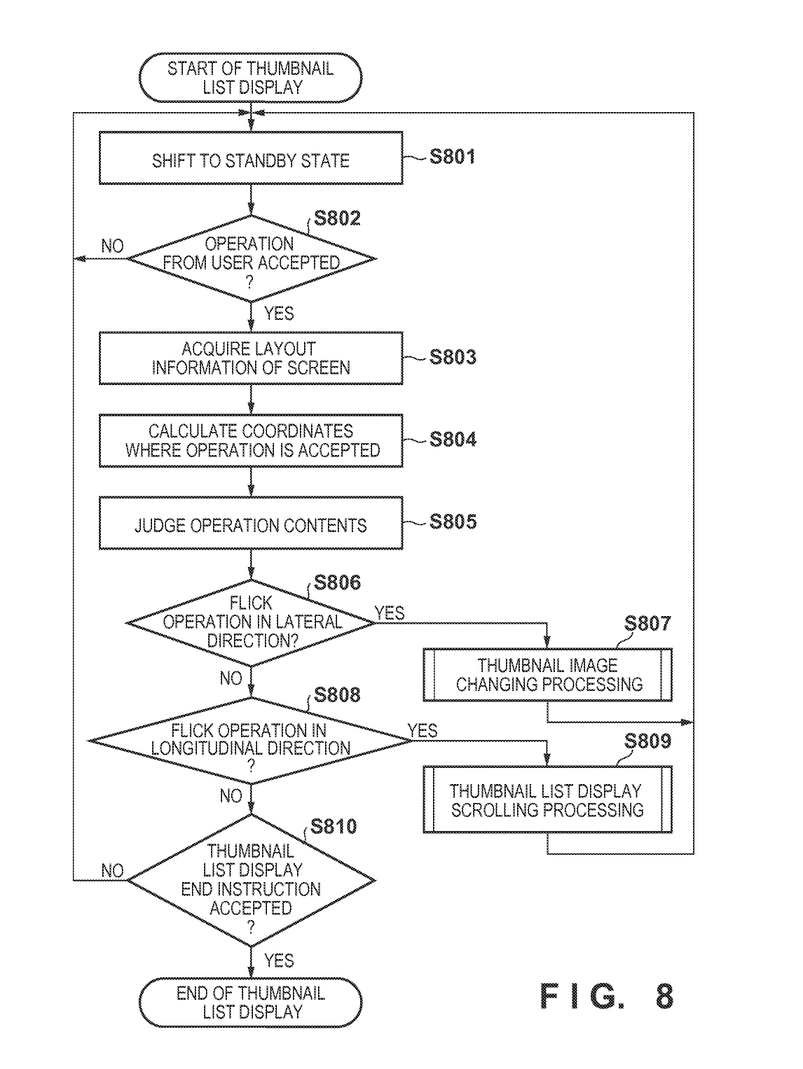

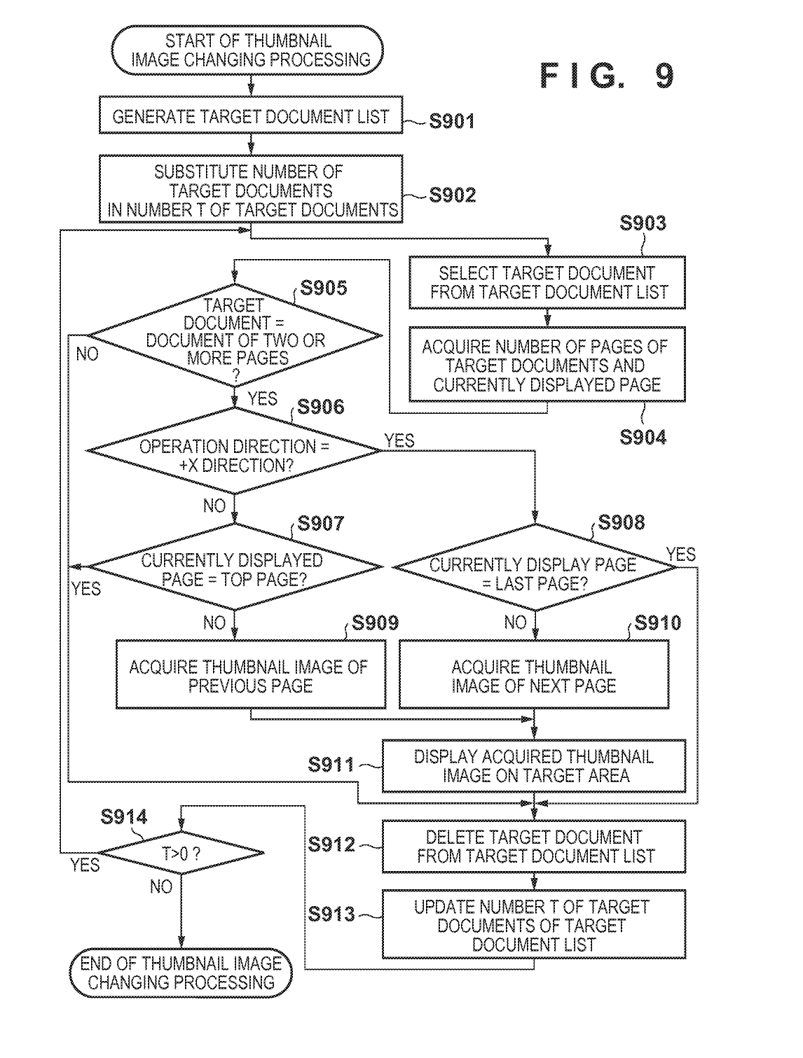

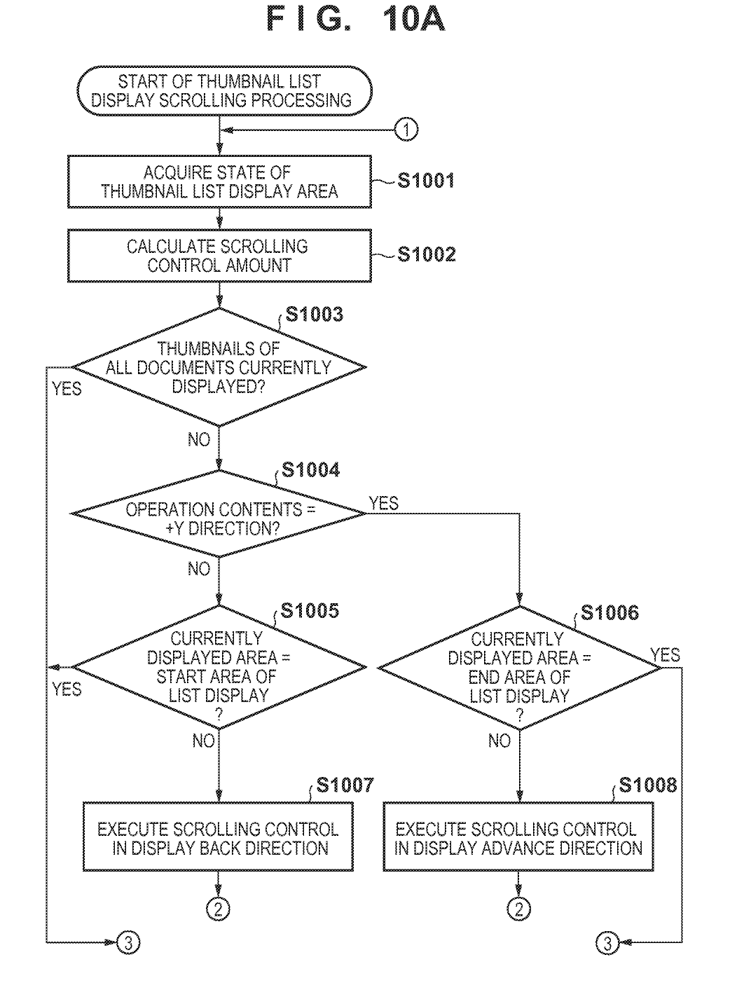

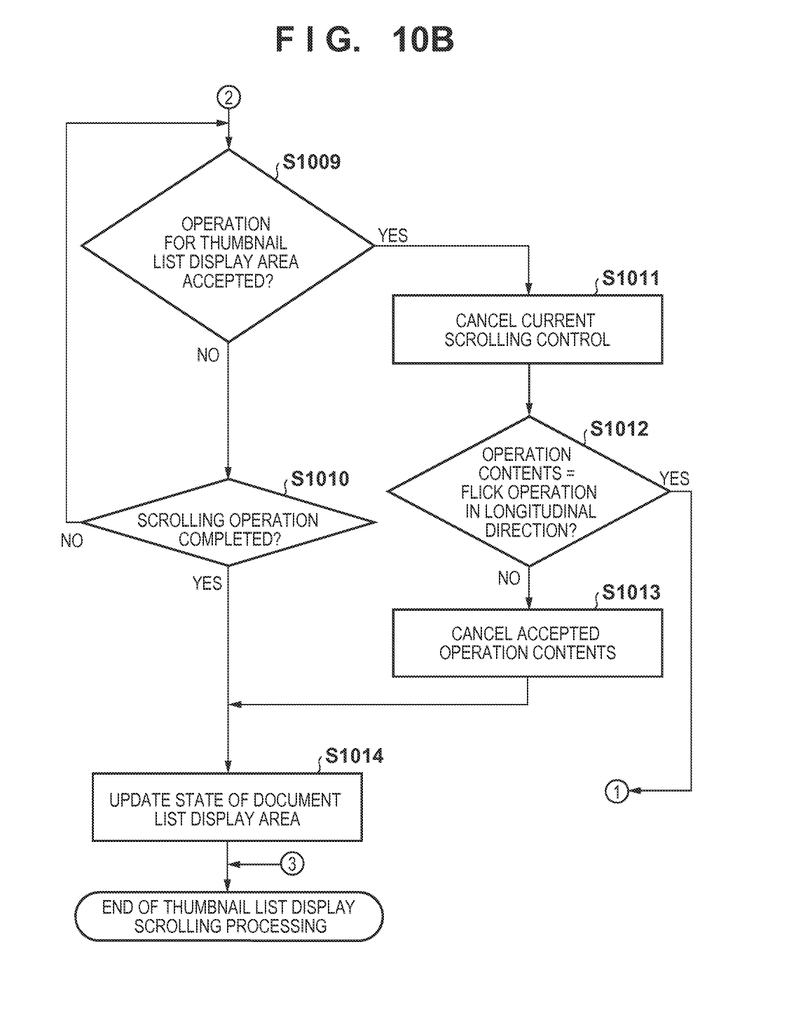

The list display control sequence of thumbnail images of this embodiment according to the flick operations described using FIGS. 5A to 7C will be described below with reference to the flowcharts shown in FIGS. 8 to 10. Note that the flowcharts shown in FIGS. 9 and 10 show the sequences of practical processes in steps S807 and S809 in FIG. 8. Processes of respective steps shown in FIGS. 8 to 10 are executed by the functional units shown in FIG. 2 in the information processing apparatus 100. That is, the processes of the respective steps are implemented by the information processing apparatus 100 when the CPU 101 loads programs stored in the ROM 102 or storage device 104 onto the RAM 103 and executes the loaded programs. Assume that data such as setting values used when the CPU 101 executes the programs are saved on the RAM 103.

The thumbnail image list display control sequence according to this embodiment will be described below with reference to FIG. 8. In the information processing apparatus 100, when the operation controller 203 accepts a display instruction of the list display screen for documents saved in the information processing apparatus 100, the sequence shown in FIG. 8 is started.

In step S801, the operation controller 203 shifts to a standby state so as to accept an operation from the user. The operation controller 203 in the standby state determines in step S802 whether or not the operation unit 105 (input unit 112) accepts an operation (touch operation) from the user. This determination process is implemented by confirming whether or not operation input information is received from the operation detector 201. If operation input information is received, it is determined that an operation from the user is accepted. If the operation controller 203 determines in step S802 that an operation from the user is accepted, the process advances to step S803; otherwise, the process returns to step S801. In step S801, the operation controller 203 functions as an accepting unit which accepts a touch operation on a display area where a list of a plurality of thumbnail images is displayed.

In step S803, the operation controller 203 acquires layout information of the screen displayed on the display area of the display unit 111 from the display controller 204. Furthermore, in step S804, the operation controller 203 calculates coordinates indicating an operation accepting position (area) in the display area of the display unit 111 based on the operation input information received in step S802 and the layout information acquired in step S803, and temporarily saves the calculation result in the RAM 103 or the like.

In step S805, the operation controller 203 judges the contents of the accepted operation (gesture operation) based on the operation input information received in step S802 and the coordinates calculated in step S804, and temporarily saves the judgment result in the RAM 103 or the like as operation information. After that, the operation controller 203 advances the process to step S806.

The operation controller 203 determines in step S806 whether or not the temporarily saved gesture operation is a flick operation in the lateral direction (first direction). If the operation controller 203 determines that the saved gesture operation is a flick operation in the lateral direction, it notifies the display controller 204 that the flick operation in the lateral direction is accepted, and the process advances to step S807. On the other hand, if the operation controller 203 determines that the saved gesture operation is not a flick operation in the lateral direction, the process advances to step S808.

The operation controller 203 determines in step S808 whether or not the temporarily saved gesture operation is a flick operation in the longitudinal direction (second direction). If the operation controller 203 determines that the saved gesture operation is a flick operation in the longitudinal direction, it notifies the display controller 204 that the flick operation in the longitudinal direction is accepted, and the process advances to step S809. On the other hand, if the operation controller 203 determines that the saved gesture operation is not a flick operation in the longitudinal direction, the process advances to step S810.

If the process advances from step S806 to step S807, the display controller 204 executes thumbnail image changing processing according to the sequence shown in FIG. 9. Upon completion of the processing, the display controller 204 returns the process to step S801. Note that in step S807, the display controller 204 functions as a thumbnail changing unit. If the process advances from step S808 to step S809, the display controller 204 executes thumbnail list display scrolling processing according to the sequence shown in FIGS. 10A and 10B. As will be described in detail later, in this scrolling processing, a list of a plurality of thumbnail images displayed on the list display area 307 is moved in the direction of the flick operation. Furthermore, thumbnail images corresponding to documents which correspond to the number of thumbnail images moved outside the list display area 307 and were not to be displayed in a list are newly displayed on the list display area 307. In this manner, the list of a plurality of thumbnail images displayed on the list display area 307 is scrolled. Upon completion of the processing, the display controller 204 returns the process to step S801. Note that in step S808, the display controller 204 functions as a scrolling unit.

On the other hand, the operation controller 203 determines in step S810 whether or not an end instruction which instructs to end the display operation of the list display screen associated with documents saved in the information processing apparatus 100 is accepted. If the operation controller 203 determines that the end instruction is not accepted, the process returns to step S801; otherwise, the display operation of the list display screen ends.

<Sequence of Thumbnail Image Changing Processing>

The practical sequence of the thumbnail image changing processing executed by the display controller 204 in step S807 will be described below with reference to FIG. 9.

In step S901, the list display processor 207 determines operation target documents of the flick operation with reference to the temporarily saved operation information. In this case, of thumbnail images displayed on the list display area 307, areas (blocks) for which the flick operation has been made are identified, and documents corresponding to the identified blocks are identified as the operation target documents. The list display processor 207 generates a target document list, and adds the identified documents to the list. Furthermore, in step S902, the list display processor 207 counts the number of documents stored in the target document list, and substitutes the obtained value in a variable T indicating the number of target documents. After that, the list display processor 207 advances the process to step S903.

In step S903, the list display processor 207 selects one document from the target document list, and sets it as a target document. A document may be selected from the target document list in a storage order of the target document list, but a selection order may be arbitrarily determined. Furthermore, in step S904, the list display processor 207 sends, to the document manager 210, an inquiry about the total number of pages and the currently displayed page of the selected target document. The document manager 210 temporarily saves information indicating the total number of pages and the currently displayed page number of the selected document in the RAM 103 or the like, and notifies the list display processor 207 of that operation.

The list display processor 207 determines in step S905 with reference to the temporarily saved total number of pages whether or not the total number of pages is 2 or more. If the total number of pages is 2 or more, the list display processor 207 advances the process to step S906; if the total number of pages is 1 or less, the process jumps to step S912.

The list display processor 207 determines in step S906 with reference to the operation information whether or not the direction of the flick operation is a +X direction (first direction) (whether the direction is a +X or −X direction). If the list display processor 207 determines that the direction of the flick operation is a −X direction (a direction opposite to the first direction), the process advances to step S907; if it determines that the direction is a +X direction, the process advances to step S908.

The list display processor 207 determines in step S907 whether or not the currently displayed page of the target document is a top page. If the list display processor 207 determines that the currently displayed page is a top page, the process jumps to step S912; otherwise, the process advances to step S909. In step S909, the list display processor 207 instructs the thumbnail image controller 208 to acquire a thumbnail image of a page immediately before the currently displayed page of the target document, and instructs the document manager 210 to change the currently displayed page number. The document manager 210 changes the managed page number according to the instruction.

The list display processor 207 determines in step S908 whether or not the currently displayed page of the target document is an end page. If the list display processor 207 determines that the currently displayed page is an end page, the process jumps to step S912; otherwise, the process advances to step S910. In step S910, the list display processor 207 instructs the thumbnail image controller 208 to acquire a thumbnail image of a page next to the currently displayed page of the target document, and instructs the document manager 210 to change the currently displayed page number. The document manager 210 changes the managed page number according to the instruction.

After step S909 or S910, the thumbnail image controller 208 instructs the thumbnail image manager 211 to read out the thumbnail image of the page designated by the list display processor 207 from the storage device 104 or the like in step S911. The thumbnail image manager 211 reads out the thumbnail image from the storage device 104 according to the instruction, temporarily saves the readout image in the RAM 103, and notifies the thumbnail image controller 208 of that operation. The thumbnail image controller 208 lays out the thumbnail image on the RAM 103 on the area (target area) corresponding to the target document on the document list buffer, and the process advances to step S912. Thus, the thumbnail image on the target area is changed in the list display area 307.

After that, the list display processor 207 deletes the current target document from the target document list in step S912, and updates the number T of target documents (decrements it by 1) in step S913. Furthermore, the list display processor 207 determines in step S914 whether or not the value of the number T of target documents is 1 or more (T>0). If the list display processor 207 determines that the value of the number T of target documents is 1 or more, the process returns to step S903; otherwise, the list display processor 207 ends the series of processes shown in FIG. 9, and returns the process to step S801.

<Sequence of Thumbnail List Display Scrolling Processing>

The practical sequence of the thumbnail list display scrolling processing executed by the display controller 204 in step S809 will be described below with reference to FIGS. 10A and 10B.

In step S1001, the list display processor 207 acquires informant of the thumbnail list display area (list display area 307) on which a list of thumbnail images are displayed, and the process advances to step S1002. In step S1002, the list display processor 207 calculates a control amount including a scrolling amount (the display position P after scrolling) and scrolling speed based on the operation information from the operation controller 203.

The list display processor 207 determines in step S1003 whether or not thumbnail images corresponding to all documents saved in the information processing apparatus 100 (storage device 104 or the like) are currently displayed on the list display area 307. If the list display processor 207 determines that thumbnail images corresponding to all the documents are currently displayed (all the documents are selected as list display targets), since the scrolling processing is not required, the scrolling processing ends, and the process returns to step S801. On the other hand, if the list display processor 207 determines that thumbnail images to be displayed still remain (some documents are not selected as list display targets), the process advances to step S1004.

In step S1004 and subsequent steps, the list display processor 207 executes processing for scrolling a list of thumbnail images displayed in the direction of a flick operation. The list display processor 207 determines in step S1004 with reference to the operation information whether or not the direction of a flick operation is a +Y direction (−Y or +Y direction). If the list display processor 207 determines that the direction of the flick operation is a −Y direction, the process advances to step S1005; if it determines that the direction is a +Y direction, the process advances to step S1006.

The list display processor 207 determines in step S1005 whether or not the currently displayed area corresponds to the start position of the document list buffer. If the list display processor 207 determines that the currently displayed area corresponds to the start position, this sequence ends, and the process advances to step S801; if it determines that the currently displayed area does not correspond to the start position, the process advances to step S1007.

The list display processor 207 determines in step S1006 whether or not the currently displayed area corresponds to the end position of the document list buffer. If the list display processor 207 determines that the currently displayed area corresponds to the end position, this sequence ends, and the process returns to step S801; if it determines that the currently displayed area does not correspond to the end position, the process advances to step S1008.

In step S1007, the list display processor 207 notifies the scrolling controller 209 of a scrolling control instruction in a display back direction together with the scrolling control amount calculated in step S1002. The scrolling controller 209 executes scrolling control according to the notified scrolling control amount in response to the instruction, and the process advances to step S1009.

On the other hand, in step S1008, the list display processor 207 notifies the scrolling controller 209 of a scrolling control instruction in a display advance direction together with the scrolling control amount calculated in step S1002. The scrolling controller 209 executes scrolling control according to the notified scrolling control amount in response to the instruction, and the process advances to step S1009.

The list display processor 207 determines in step S1009 whether or not an operation for the thumbnail list display area (list display area 307) is accepted during execution of the scrolling control by the scrolling controller 209. If the list display processor 207 determines that the operation is accepted, the process advances to step S1011; otherwise, the process advances to step S1010. The scrolling controller 209 determines in step S1010 whether or not the scrolling operation of thumbnail images displayed on the list display area 307 is complete. If the scrolling controller 209 determines that the scrolling operation is complete, the process advances to step S1014; otherwise, the process returns to step S1009.

On the other hand, in step S1011, the list display processor 207 instructs the scrolling controller 209 to stop the scrolling control. The scrolling controller 209 stops the scrolling operation in accordance with the instruction, and the process advances to step S1012. The list display processor 207 determines in step S1012 whether or not the operation accepted in step S1009 is a flick operation in the longitudinal direction. If the list display processor 207 determines that the accepted operation is a flick operation in the longitudinal direction, the process advances to step S1001; otherwise, the process returns to step S1013. In step S1013, the list display processor 207 discards the operation information indicating the operation accepted in step S1009 to cancel the operation, and the process advances to step S1014.

In step S1014, the display screen configuration unit 206 updates the display state of the list display area 307, and ends the processing of this sequence. The process then returns to step S801.

As described above, the information processing apparatus 100 according to this embodiment accepts a touch operation for the list display area while it displays a list of thumbnail images corresponding to documents saved in itself. When the accepted touch operation is a flick operation in the lateral direction, the information processing apparatus 100 changes a thumbnail image displayed on the area for which the flick operation has been made to that of a different page (for example, a previous or next page) included in the corresponding document. When the accepted touch operation is a flick operation in the longitudinal direction, the information processing apparatus 100 scrolls a list of a plurality of thumbnail images displayed on the display area in the direction of that flick operation.

Thus, when the user confirms a list display of documents (thumbnail images), he or she can confirm documents, which are not displayed, by scrolling the screen by a flick operation without switching the display screen. Also, the user can confirm the contents of respective pages of each document by changing thumbnail images by a flick operation without switching the display screen. Furthermore, these operations can be selectively used by switching the direction of the flick operation. Therefore, according to this embodiment, when a list of thumbnail images corresponding to documents saved in the information processing apparatus are displayed, the list display can be scrolled and thumbnail images can be switched by simple flick operations without switching the display screen. As a result, the user can efficiently find out a desired document file from those saved in the information processing apparatus 100.

Note that determination of a gesture operation (flick operation) based on its direction in this embodiment is merely an example, and other determination methods may be used. For example, the directions (first and second directions) of the gesture operation to be associated with determination results may be exchanged.

### Second Embodiment

The first embodiment has explained the case in which the display control of the list display of thumbnail images corresponding to documents saved in the information processing apparatus 100 is executed according to the direction of the accepted flick operation. Upon execution of such display control according to the direction of the flick operation, since the direction of the scrolling operation may be limited, operations that the user can make are likely to be limited.

Hence, the second embodiment is characterized in that the display control of the list display of thumbnail images corresponding to documents saved in the information processing apparatus 100 is executed according to an area for which a flick operation has been made in the list display area 307. In this embodiment, the hardware arrangement and functional arrangement of the information processing apparatus 100 are the same as those (FIGS. 1 and 2) in the first embodiment. Differences from the first embodiment will be mainly described below for the sake of simplicity.

<Screen Control in response to Gesture Operation>

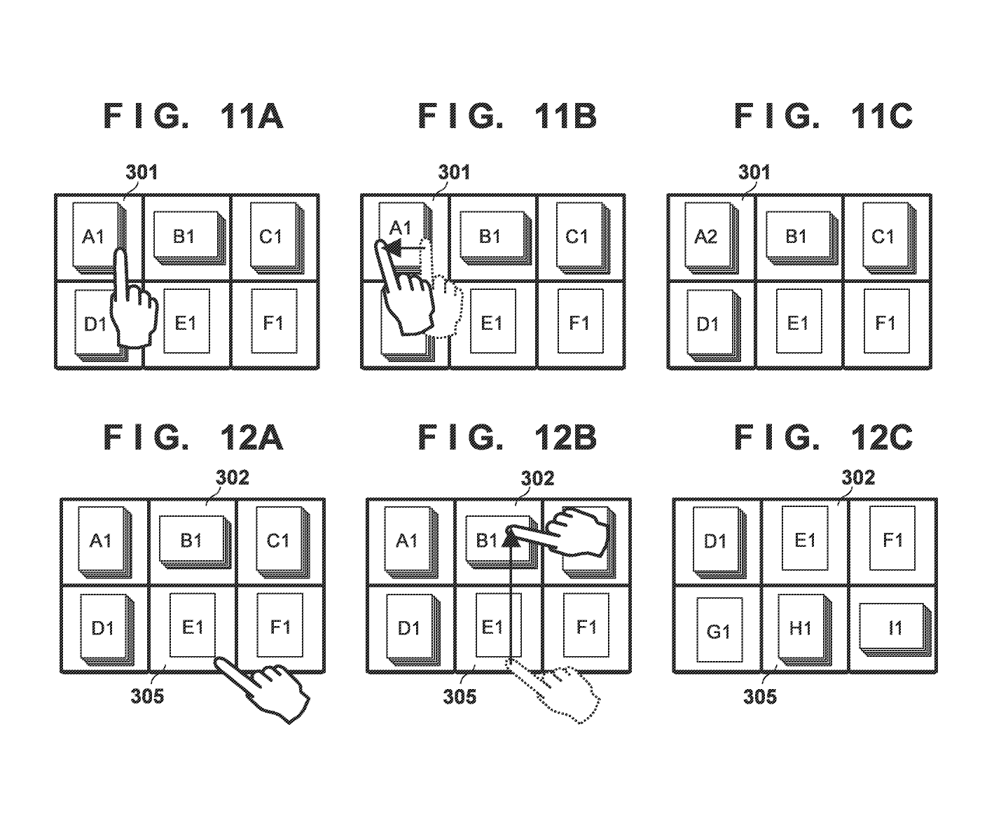

Transition of a display screen in the list display area 307 and processes of the respective functional units when a gesture operation for the list display area 307 of the list display screen 300 is accepted by the operation unit 105 will be described below with reference to FIGS. 11A to 14C. In this embodiment, the display state of a screen in the list display area 307 is controlled based on a gesture operation (flick operation) of the user made for the divided blocks 301 to 306 in the list display area 307. Note that in this embodiment, the display position P is information which identifies an area, in which image data of a thumbnail image to be displayed on the block 301 is stored, of those in the document list buffer, and indicates a row and column of that area.

A case will be described first with reference to FIGS. 11A to 11C wherein a flick operation for any one of the blocks 301 to 306 in the list display area 307 is accepted as a gesture operation. As shown in FIG. 11A, the user touches a position (area) corresponding to any one (block 301) of the blocks 301 to 306 on the touch panel of the input unit 112. Furthermore, the user makes a flick operation within that block to have the touched position as a start point, as shown in FIG. 11B. That is, the user makes a flick operation for an area (block) on which one thumbnail image is displayed in the list display area 307.

Upon determining that such flick operation is accepted, the operation controller 203 instructs the display controller 204 to change a thumbnail image for a document corresponding to the block for which the operation has been made. In the display controller 204, the thumbnail image controller 208 executes changing processing of a thumbnail image displayed on the block as a flick operation target in accordance with the instruction from the operation controller 203. More specifically, as shown in FIG. 11C, the thumbnail image controller 208 changes the thumbnail image displayed on the block 301 as the flick operation target from a thumbnail image A1 of a top page to a thumbnail image A2 of the next image. In this manner, the thumbnail image controller 208 changes the thumbnail image displayed on the area (block 301) for which the flick operation has been made to that of a different page (in this case, the next page) included in the corresponding document.

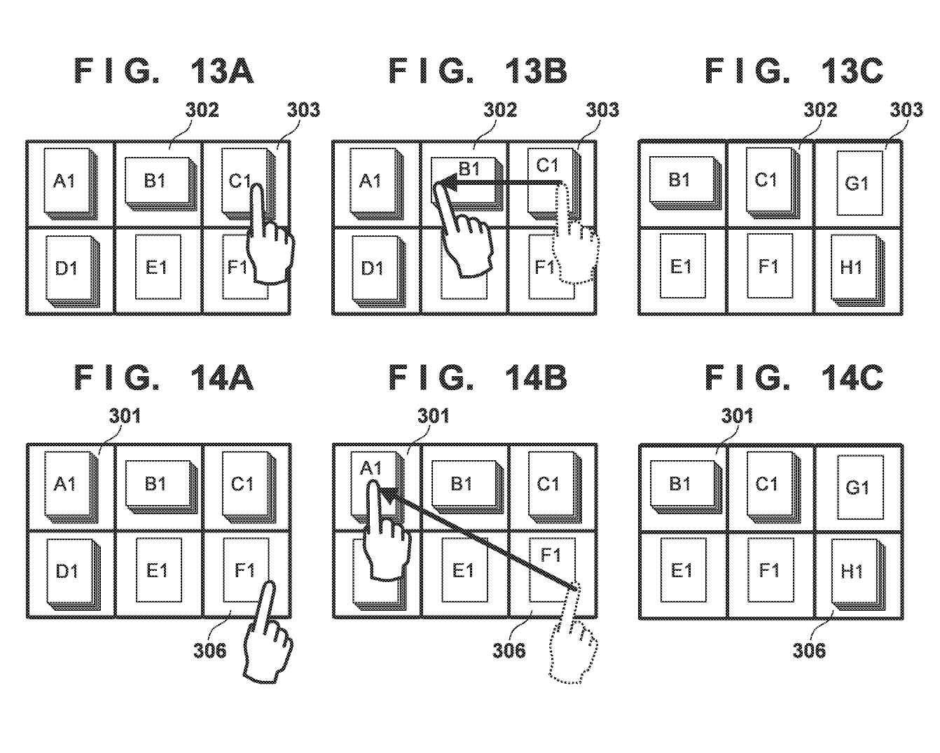

A case will be described below with reference to FIGS. 12A to 12C and FIGS. 13A to 13C wherein a flick operation across a plurality of blocks in the list display area 307 is accepted as a gesture operation. FIGS. 12A to 12C shows a case in which a flick operation in the longitudinal direction is accepted. As shown in FIG. 12A, the user touches a position (area) corresponding to any one (block 305) of the blocks 301 to 306 in the list display area 307 on the touch panel of the input unit 112. Furthermore, as shown in FIG. 12B, the user makes a flick operation in the longitudinal direction from the touched position across a plurality of blocks (from the block 305 to the block 302) to have the touched position as a start point.

Upon determining that such flick operation is accepted, the operation controller 203 instructs the display controller 204 to execute scrolling processing in the longitudinal direction for the display contents (list display of thumbnail images) in the list display area 307. The list display processor 207 changes the display position P according to the instruction, and instructs the scrolling controller 209 to execute scrolling processing based on the changed display position P. The scrolling controller 209 executes the scrolling processing of the display contents to change the display contents in the list display area 307 to those corresponding to the display position P according to the instruction. As a result, the display contents in the list display area 307 are changed from those shown in FIG. 12A to those shown in FIG. 12C.

On the other hand, FIGS. 13A to 13C show a case in which a flick operation in the lateral direction is accepted as an example. As shown in FIG. 13A, the user touches a position (area) corresponding to any one (block 303) of the blocks 301 to 306 in the list display area 307 on the touch panel of the input unit 112. Furthermore, as shown in FIG. 13B, the user makes a flick operation in the lateral direction from the touched position across a plurality of blocks (from the block 303 to the block 302) to have the touched position as a start point.

Upon determining that such flick operation is accepted, the operation controller 203 instructs the display controller 204 to execute scrolling processing in the lateral direction for the display contents (list display of thumbnail images) in the list display area 307. The list display processor 207 changes the display position P according to the instruction, and instructs the scrolling controller 209 to execute scrolling processing based on the changed display position P. The scrolling controller 209 executes the scrolling processing of the display contents to change the display contents in the list display area 307 to those corresponding to the display position P according to the instruction. As a result, the display contents in the list display area 307 are changed from those shown in FIG. 13A to those shown in FIG. 13C.

A case will be described below with reference to FIGS. 14A to 14C wherein a flick operation in a direction (oblique direction) other than the aforementioned longitudinal and lateral directions is accepted as that across a plurality of blocks in the list display area 307. As shown in FIG. 14A, the user touches a position (area) corresponding to any one (block 306) of the blocks 301 to 306 in the list display area 307 on the touch panel of the input unit 112. Furthermore, as shown in FIG. 14B, the user makes a flick operation in the oblique direction from the touched position across a plurality of blocks (from the block 306 to the block 301) to have the touched position as a start point.

Upon determining that such flick operation is accepted, the operation controller 203 determines if the operation position of the flick operation has moved from the block as the start point to any of neighboring blocks in the longitudinal or lateral direction first. The operation controller 203 instructs the display controller 204 to execute scrolling processing in a direction (lateral direction in FIGS. 14A to 14C) in which the first moved neighboring block is located based on the determination result. The list display processor 207 changes the display position P according to the instruction, and instructs the scrolling controller 209 to execute scrolling processing based on the changed display position P. The scrolling controller 209 executes the scrolling processing of the display contents to change the display contents in the list display area 307 to those corresponding to the display position P according to the instruction. As a result, the display contents in the list display area 307 are changed from those shown in FIG. 14A to those shown in FIG. 14C.

As shown in FIGS. 12A to 14C, the scrolling controller 209 scrolls a plurality of thumbnail images displayed in the list display area 307 in a direction of a flick operation in accordance with the flick operation across areas on which two or more neighboring thumbnail images are displayed.

<Determination Processing for Flick Operation in One Block>

In this embodiment, as shown in FIGS. 11A to 11C, when the flick operation is made in one block, the processing for changing a thumbnail image displayed on that block to that of a different page of a corresponding document is executed. In this case, the display controller 204 has to decide to which page of thumbnail image of the corresponding document that thumbnail image is to be changed (whether to advance or back a page). In this embodiment, according to a direction of a flick operation in an area (block) on which one thumbnail image is displayed, to which page of a thumbnail image that one thumbnail image is to be changed (a page changing direction) is decided. That is, according to the direction of the flick operation, whether the thumbnail image is to be changed to that of the next page or immediately preceding page in a corresponding document is decided.

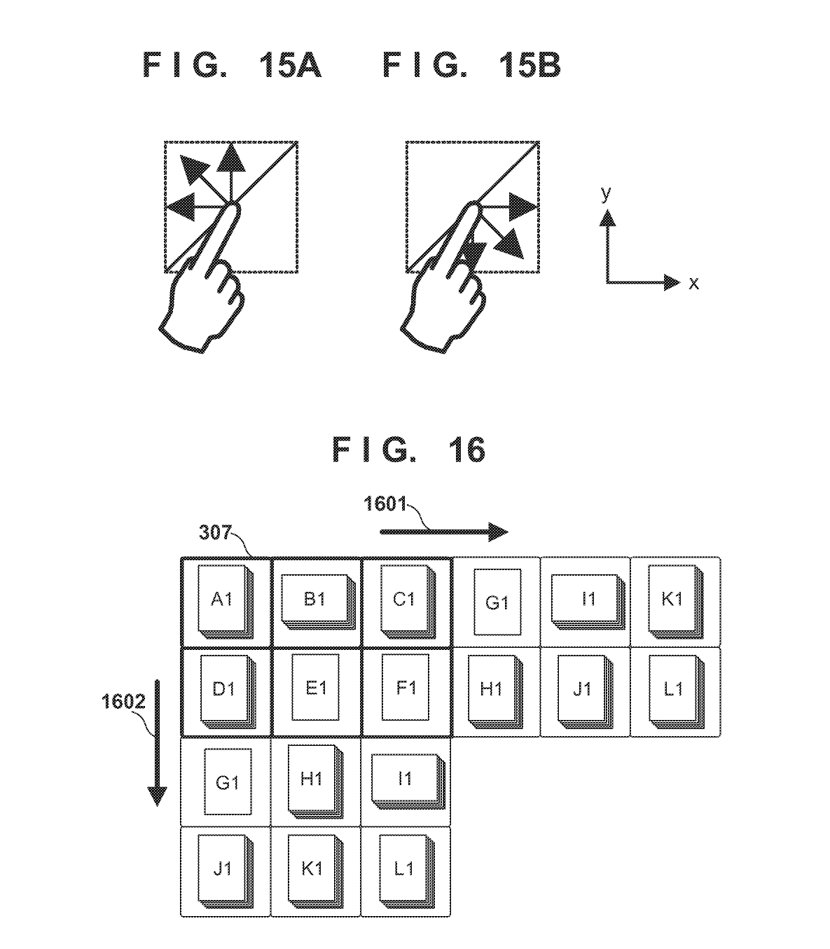

FIGS. 15A and 15B show an example of the aforementioned decision processing. When a flick operation accepted in one block is, for example, that in one of directions shown in FIG. 15A, it is decided to advance a page of a document corresponding to a thumbnail image displayed on that block. On the other hand, when a flick operation is, for example, that in one of directions shown in FIG. 15B, it is decided to back a page of a document corresponding to a thumbnail image displayed on that block. Note that such decision processing can be executed by the list display processor 207 based on the operation information from the operation controller 203. Note that the aforementioned decision method is an example, and a correspondence relationship between directions of a flick operation and decision as to whether to advance or back a page may be different.

<Configuration of Document List Buffer in Longitudinal and Lateral Directions>

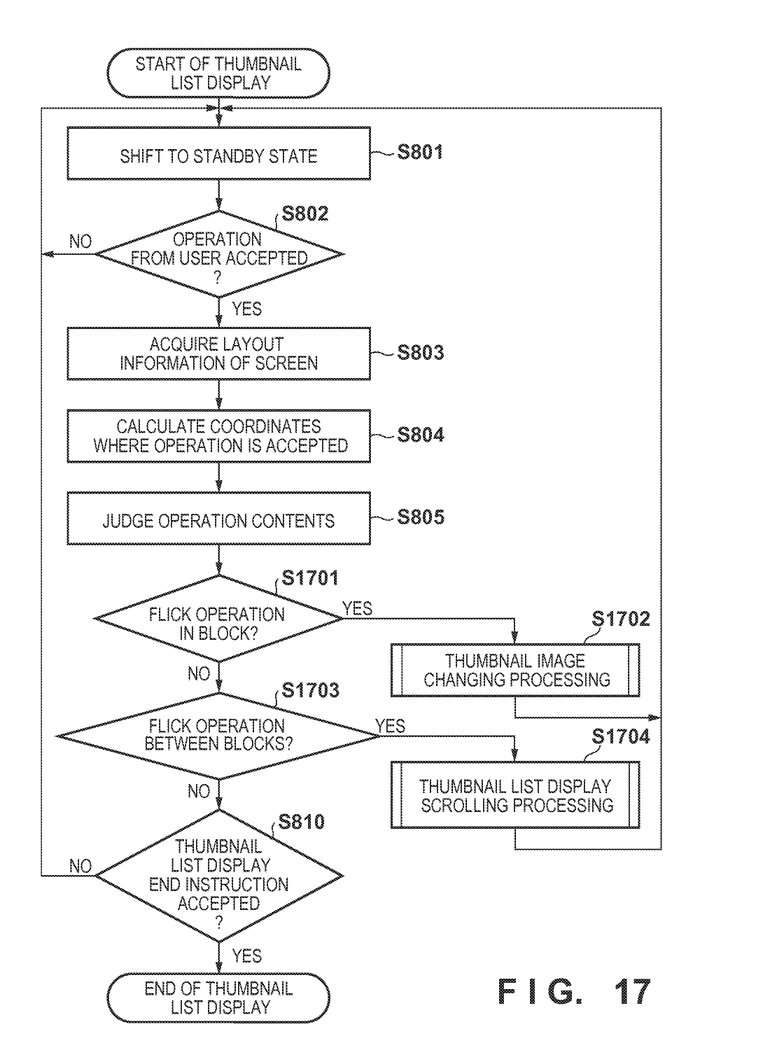

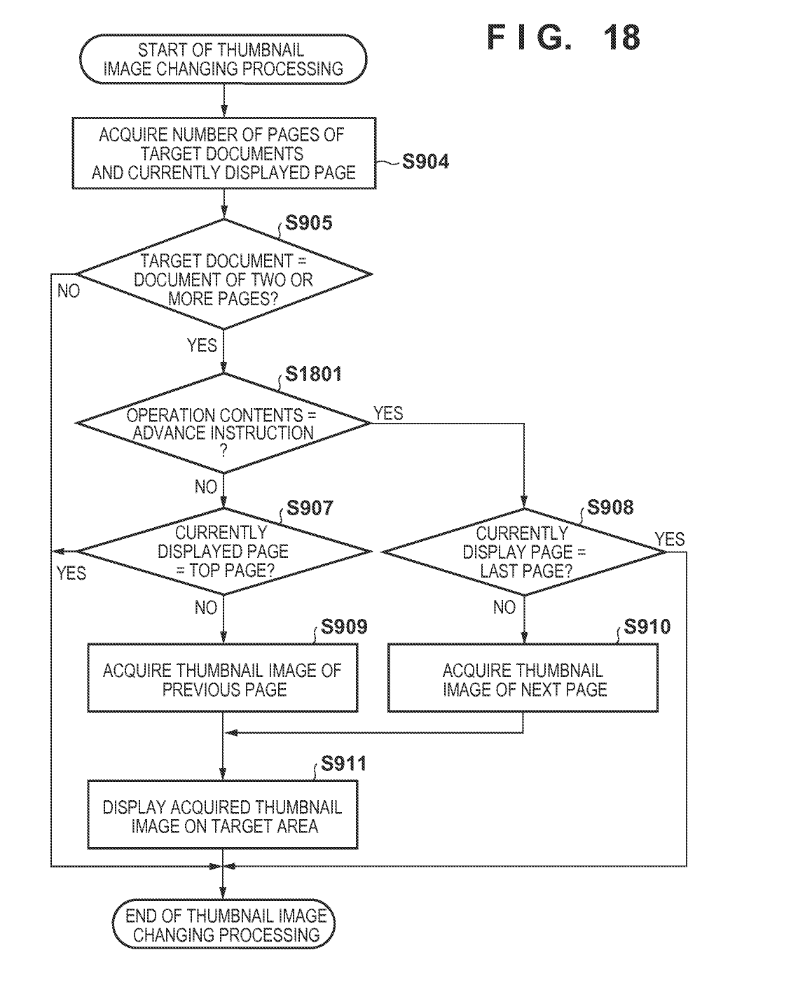

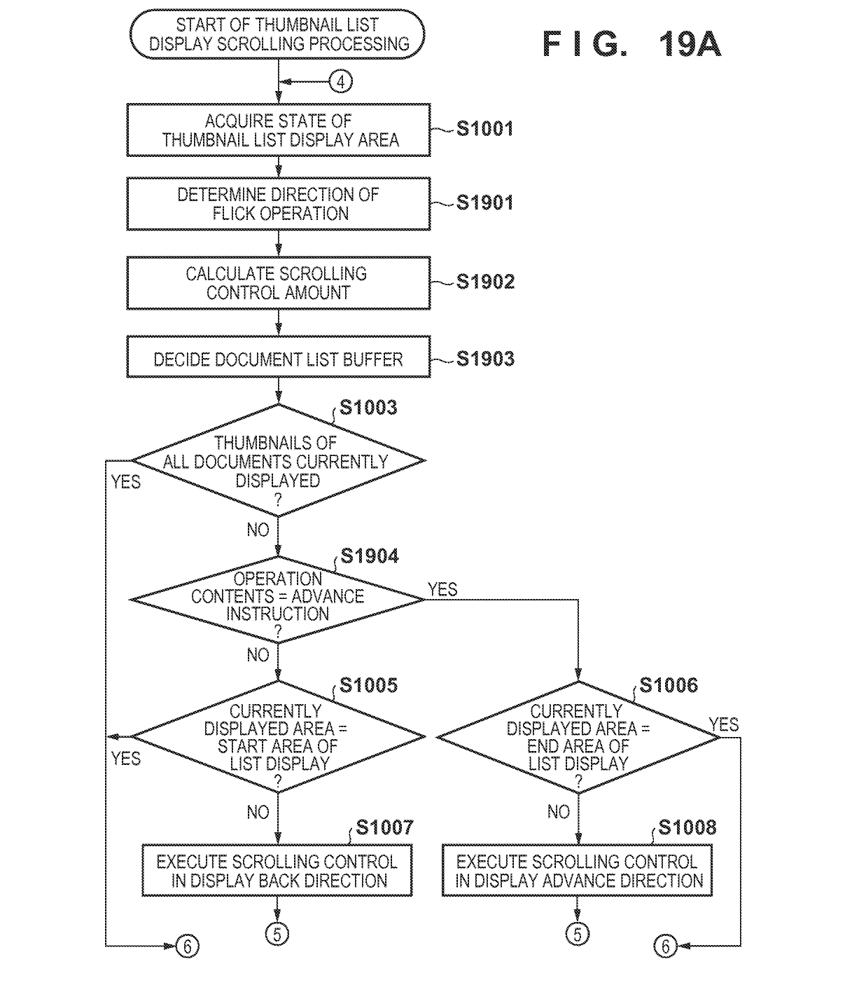

In this embodiment, the scrolling control for a document list display can be executed not only in the longitudinal direction as in the first embodiment but also in two directions, that is, the longitudinal and lateral directions. For this purpose, the list display processor 207 has to generate a document list buffer corresponding to the respective scrolling directions, as shown in, for example, FIG. 16.

The document list buffer can be generated according to the number of divided areas (blocks) included in the list display area 307. In FIG. 16, the same as in the first embodiment (FIGS. 4A to 4C) applies to the longitudinal direction (a direction of an arrow 1602). On the other hand, to prepare for scrolling processing in the lateral direction (a direction of an arrow 1601) for the document list display, areas of the predetermined number also have to be assured as a buffer in the lateral direction. In FIG. 16, on the right side of the areas of the document list buffer currently corresponding to the list display area 307, new areas of 2 rows×3 columns are assured. On these new areas, thumbnail images corresponding to documents, which are not to be displayed on the list display area 307, can be laid out in turn, as shown in FIG. 16.

<Thumbnail List Display Control Sequence in response to Gesture Operation>

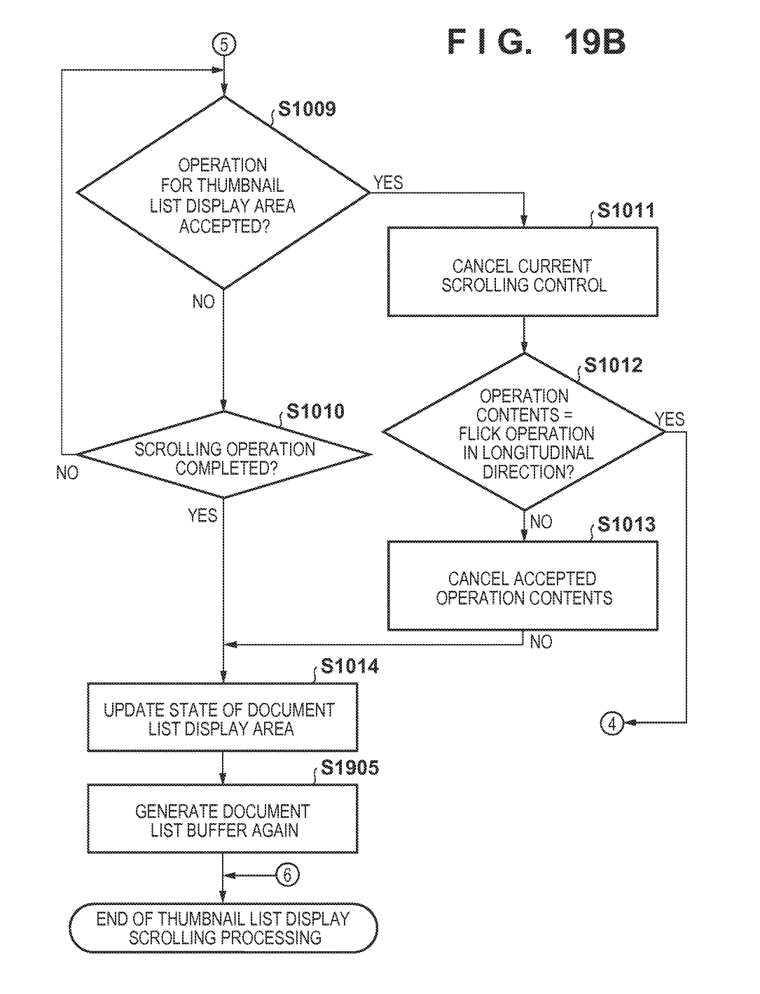

The thumbnail image list display control sequence according to this embodiment according to the flick operations described using FIGS. 11A to 14C will be described below with reference to FIGS. 17 to 19. Note that the flowcharts shown in FIGS. 18 and 19 show the sequence of the practical processes in steps S1702 and S1704 in FIG. 17. The processes of respective steps shown in FIGS. 17 to 19 are executed by the functional units shown in FIG. 2 in the information processing apparatus 100. More specifically, the processes of the respective steps are implemented by the information processing apparatus 100 when the CPU 101 loads programs stored in the ROM 102 or storage device 104 onto the RAM 103 and executes the loaded programs. Assume that data such as setting values used when the CPU 101 executes the programs are saved on the RAM 103. Also, the same step numbers as those in the first embodiment (FIGS. 8 to 10) denote the steps which execute the same processes as those in the first embodiment, and a description thereof will not be repeated for the sake of simplicity.

The thumbnail image list display control sequence according to this embodiment will be described below with reference to FIG. 17. In the information processing apparatus 100, when the operation controller 203 accepts a display instruction of the list display screen associated with documents saved in the information processing apparatus 100, the sequence shown in FIG. 17 is started. Steps S801 to S805 are the same as those in the first embodiment.

The operation controller 203 determines in step S1701 whether or not the temporarily saved gesture operation is a flick operation in one specific block. If the operation controller 203 determines that the saved gesture operation is a flick operation in one specific block, it notifies the display controller 204 of that operation, and the process advances to step S1702. On the other hand, if the operation controller 203 determines that the saved gesture operation is not a flick operation in one specific block, the process advances to step S1703.

The operation controller 203 determines in step S1703 whether or not the temporarily saved gesture operation is a flick operation across two or more specific blocks (between blocks). If the operation controller 203 determines that the saved gesture operation is a flick operation across two or more specific blocks, it notifies the display controller 204 of that operation, and the process advances to step S1704. On the other hand, if the operation controller 203 determines that the saved gesture operation is not a flick operation across two or more specific blocks, the process advances to step S810.

If the process advances from step S1701 to step S1702, the display controller 204 executes thumbnail image changing processing according to the sequence shown in FIG. 18. After completion of the processing, the display controller 204 returns the process to step S801. Note that in step S1702, the display controller 204 functions as a thumbnail changing unit. If the process advances from step S1703 to step S1704, the display controller 204 executes the thumbnail list display scrolling processing according to the sequence shown in FIGS. 19A and 19B. After completion of the processing, the display controller 204 returns the process to step S801. Note that in step S1704, the display controller 204 functions as a scrolling unit.

On the other hand, the processing in step S810 and subsequent steps is the same as in the first embodiment.

|Thumbnail Image Changing Processing Sequence>

The practical sequence of the thumbnail image changing processing executed by the display controller 204 in step S1702 will be described below with reference to FIG. 18.

Steps S904 and S905 are the same as those in the first embodiment. The list display processor 207 determines in step S905 with reference to the temporarily saved total number of pages whether or not the total number of pages is 2 or more. If the total number of pages is 2 or more, the list display processor 207 advances the process to step S1801; if the total number of pages is 1 or less, this sequence ends, and the process returns to step S801 (FIG. 17).

The list display processor 207 determines in step S1801 with reference to the operation information whether or not to advance a page corresponding to a thumbnail image as a result of decision based on the decision method described using, for example, FIGS. 15A and 15B. If the list display processor 207 determines that a page is to be advanced, the process advances to step S908, if it determines that a page is to be backed, the process advances to step S907.

Steps S907 to S911 are the same as those in the first embodiment. In this way, this sequence ends, and the process returns to step S801.

<Sequence of Thumbnail List Display Scrolling Processing>

The practical sequence of the thumbnail list display scrolling processing executed by the display controller 204 in step S1704 will be described below with reference to FIGS. 19A and 19B.

Step S1001 is the same as that in the first embodiment. After step S1001, the process advances to step S1901. In step S1901, the list display processor 207 determines a direction of a flick operation based on the operation information from the operation controller 203, and temporarily saves the determined contents together with the operation information. In this case, the operation direction can be determined, as described above using FIGS. 14A to 14C. After that, the list display processor 207 advances the process to step S1902.

In step S1902, the list display processor 207 calculates a control amount including a scrolling amount (the display position P after scrolling) by the scrolling processing and a scrolling speed based on the direction determined in step S1901 and the number of blocks between which the operation position by the flick operation has moved (which have undergone the flick operation).

In step S1903, the list display processor 207 decides whether to use the document list buffer in the longitudinal direction or that in the lateral direction according to the determined contents saved in step S1902, as shown in FIG. 16. Note that in this embodiment, of areas included in the document list buffer, those which are not used depending on the scrolling direction are deleted. After that, the list display processor 207 advances the process to step S1003. Step S1003 is the same as that in the first embodiment.

If the list display processor 207 determines in step S1003 that thumbnail images to be displayed remain (some documents are not selected as list display targets), the process advances to step S1904. The list display processor 207 determines in step S1904 whether or not to advance scrolling (advance or back direction) along the longitudinal or lateral direction, and supplies an instruction according to that determination result to the scrolling controller 209. If the list display processor 207 supplies an instruction in a scrolling advance direction to the scrolling controller 209 in step S1904, the process advances to step S1006; if it supplies an instruction in a back direction, the process advances to step S1005.

Steps S1005 to S1014 are the same as those in the first embodiment. After step S1014, the list display processor 207 updates the document list buffer in the used direction, and generates the areas of the document list buffer deleted in step S1903 again based on the current display position P in step S1905. In this way, this sequence ends, and the process returns to step S801 (FIG. 17).

As described above, according to this embodiment, the display control of the list display of thumbnail images corresponding to documents saved in the information processing apparatus 100 is executed according to an area for which the flick operation has been made in the list display area 307. Thus, in addition to the advantages of the first embodiment, the degrees of freedom in operations the user can make can be further improved. Also, since the degrees of freedom in flick operations upon execution of the thumbnail image changing processing can also be improved, operation errors of the user can be reduced, and the user can make intuitive operations.

### Third Embodiment

According to the first and second embodiments, the user can instruct to execute changing processing of a thumbnail image of a specific document and scrolling processing of a list display by flick operations for the list display area 307 on which a list of thumbnail images of documents saved in the information processing apparatus 100 are displayed. In this case, it is helpful to instruct to display a list of thumbnail images of respective pages for a specific document in addition to the aforementioned instructions.

Hence, the third embodiment is characterized in that a list display instruction of thumbnail images of respective pages of a specific document is allowed to be designated by a simple gesture operation (touch operation) with respect to the display control of the thumbnail list display according to the first and second embodiments. In this embodiment, the hardware arrangement and functional arrangement of the information processing apparatus 100 are the same as those in the first and second embodiments (FIGS. 1 and 2). Only differences from the first and second embodiments will be mainly described below for the sake of simplicity.

<Example of List Display Screen of Specific Document>

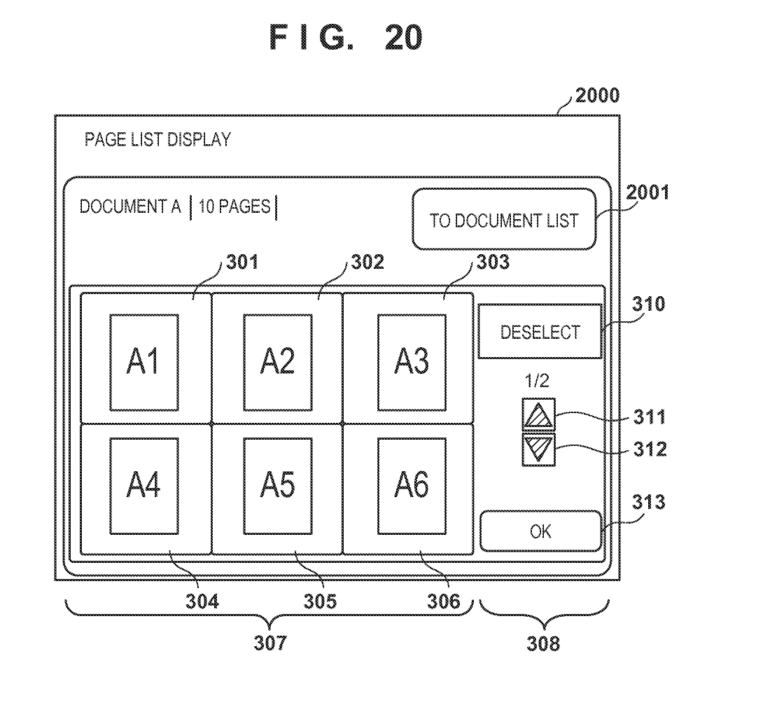

An example of a list display screen of pages included in a specific document, which screen is displayed on the display unit 111, in the information processing apparatus 100 according to this embodiment and operation examples via the screen will be described below with reference to FIG. 20. As shown in FIG. 20, a list display screen 2000 is nearly the same as the list display screen 300 shown in FIG. 3. Unlike in the list display screen 300, thumbnail images of respective pages included in a specific document are displayed on the blocks 301 to 306, and a document list button 2001 is displayed.

When the user executes a hold operation for a predetermined time period and then a flick operation to follow the hold operation for the list display area 307 while the document list display screen 300 (FIG. 3) is displayed on the display unit 111, the display contents of the display unit 111 are temporarily switched to those of the list display screen 2000. More specifically, upon accepting a hold operation for a predetermined time period and a flick operation which follows the hold operation for an area (block) on which one thumbnail image is displayed in the list display area 307 of the list display screen 300, the display controller 204 displays the list display screen 2000. On the list display screen 2000, thumbnail images of a plurality of pages included in a document corresponding to the area which has undergone the above operations are displayed in the list display area 307.

On the list display screen 2000, a document list button 2001 is used to return a display screen from the list display screen 2000 to the list display screen 300. When the user presses (makes a touch operation on) the document list button 2001, the display contents of the display unit 111 are switched to the list display screen 300 required to display a list of documents.

<Thumbnail List Display Control Sequence in Response to Gesture Operation>

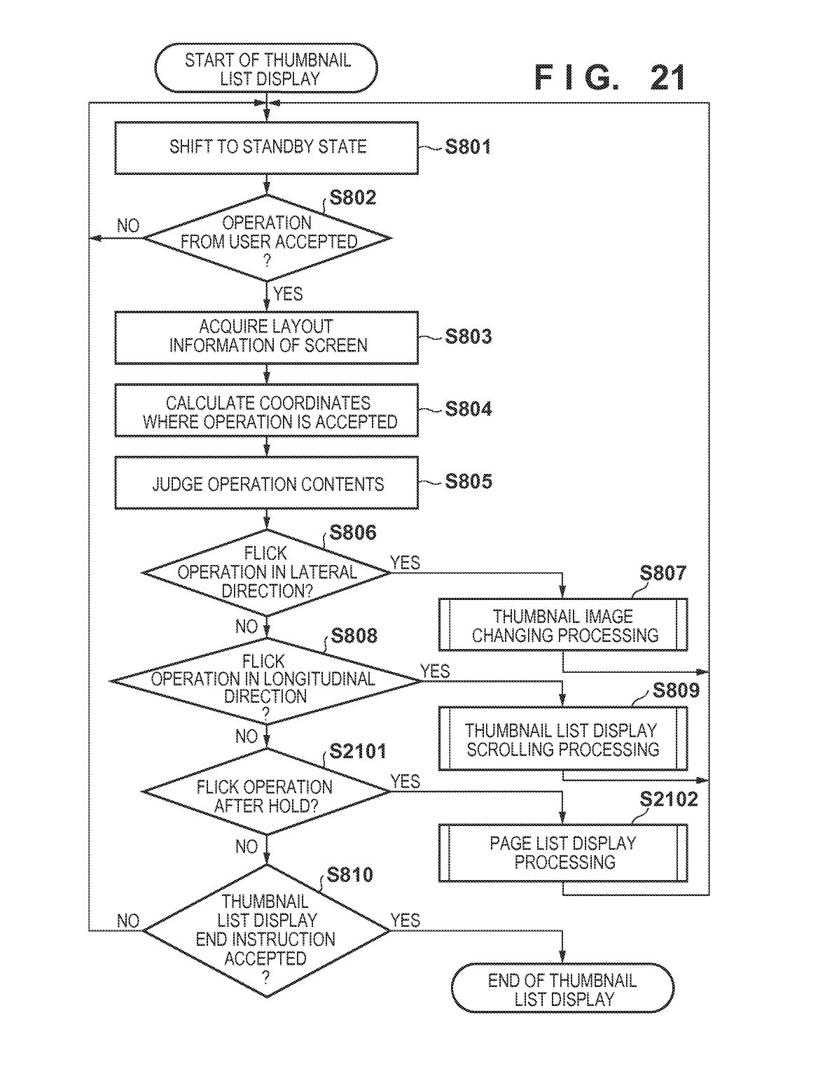

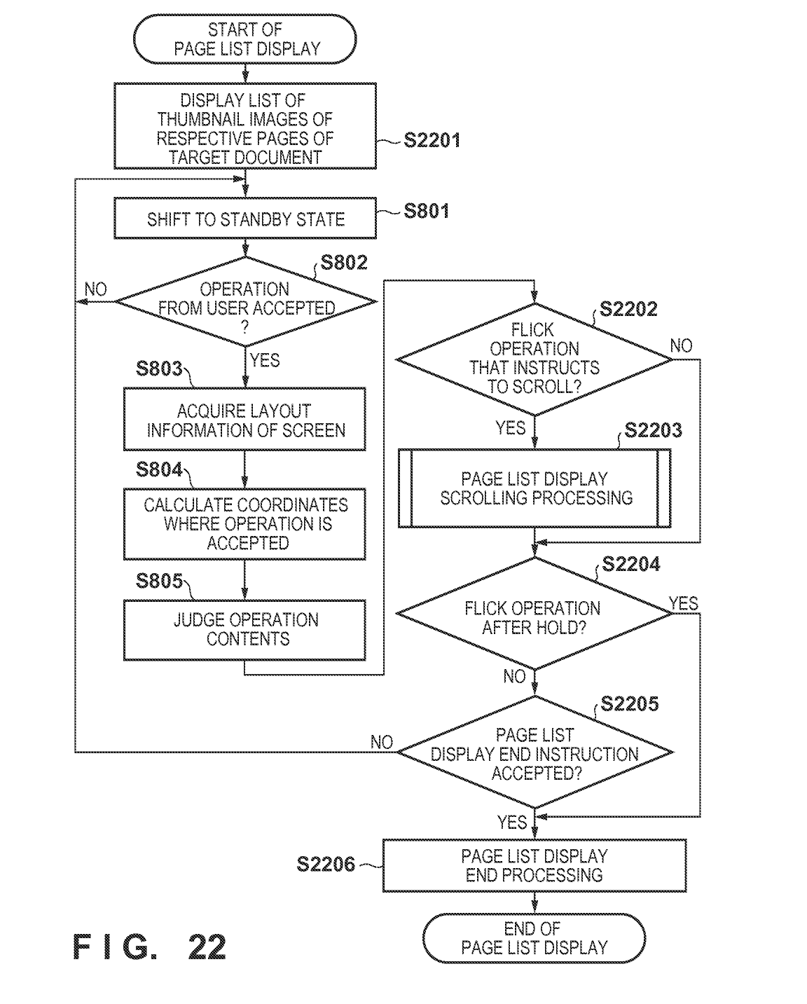

The thumbnail image list display control sequence according to this embodiment will be described below with reference to the flowcharts shown in FIGS. 21 and 22. Note that the flowchart shown in FIG. 22 shows the sequence of the practical processing in step S2102 in FIG. 20. Processes of respective steps shown in FIGS. 21 and 22 are executed by the respective functional units shown in FIG. 2 in the information processing apparatus 100. That is, the processes of the respective steps are implemented by the information processing apparatus 100 when the CPU 101 loads programs stored in the ROM 102 or storage device 104 onto the RAM 103 and executes the loaded programs. Assume that data such as setting values used when the CPU 101 executes the programs are saved on the RAM 103.

The thumbnail image list display control sequence according to this embodiment will be described below with reference to FIG. 21. In the information processing apparatus 100, when the operation controller 203 accepts a display instruction of the list display screen for documents saved in the information processing apparatus 100, the sequence shown in FIG. 21 is started. Steps S801 to S809 are the same as those in the first embodiment.

If the operation controller 203 determines in step S808 that the temporarily saved gesture operation is not a flick operation in the longitudinal direction, the process advances to step S2101. The operation controller 203 determines in step S2101 whether or not the temporarily saved gesture operation is a flick operation after a hold operation (a hold operation for a predetermined time period and a flick operation which follows the hold operation). If the operation controller 203 determines that the saved gesture operation is a flick operation after a hold operation, it notifies the display controller 204 of that operation, and the process advances to step S2102. On the other hand, otherwise, the operation controller 203 advances the process to step S810. Step S810 is the same as that in the first embodiment.

In step S2102, the display controller 204 executes page list display processing for a specific document corresponding to a thumbnail image displayed on the area (block) for which the gesture operation has been made in accordance with the sequence shown in FIG. 22. After completion of the processing, the display controller 204 returns the process to step S801. Note that in step S2102, the display controller 204 functions as a switching unit.

### <Sequence of Page List Display Processing>

The practical sequence of the page list display processing executed in step S2102 will be described below with reference to FIG. 22.

In step S2201, the display controller 204 switches the display contents of the display unit 111 from the list display screen 300 to the list display screen 2000. Furthermore, the display controller 204 displays thumbnail images of respective pages of a specific document as a target of the page list display processing based on the aforementioned gesture operation on the list display area 307 (blocks 301 to 306) of the list display screen 2000. After that, the display controller 204 advances the process to step S801.

Steps S801 to S805 are the same as those in FIG. 8, and the operation controller 203 accepts a touch operation from the user. The operation controller 203 determines in step S2202 whether or not the temporarily saved gesture operation is a flick operation which instructs to scroll the list display on the list display area 307. The determination process in step S2202 can be implemented in the same manner as that based on, for example, the direction of the flick operation or the areas (blocks 301 to 306) for which the flick operation has been made, as described in the first and second embodiment. If the operation controller 203 determines that the saved gesture operation is a flick operation which instructs to scroll the list display, it notifies the display controller 204 of that operation, and the process advances to step S2203; otherwise, the process advances to step S2204.

In step S2203, the scrolling processing of the list display of thumbnail images of respective pages on the list display area 307 is executed. In this case, processing corresponding to the determination method used in step S2202 need only be executed. The thumbnail list display scrolling processing is executed using a thumbnail list buffer equivalent to the document list buffer in place of the document list buffer. For example, when the determination processing based on the direction of a flick operation as in the first embodiment is adopted in step S2202, the sequence shown in FIGS. 10A and 10B is executed. On the other hand, when the determination processing based on areas (blocks 301 to 306) for which the flick operation has been made as in the second embodiment is adopted in step S2202, the sequence shown in FIGS. 19A and 19B is executed. After completion of the processing in step S2203, the process advances to step S2204.

The operation controller 203 determines in step S2204 whether the temporarily saved gesture operation is a flick operation after a hold operation as in step S2101. If the operation controller 203 determines that the saved gesture operation is a flick operation after a hold operation, it notifies the display controller 204 of that operation, and the process advances to step S2206. On the other hand, if the operation controller 203 determines that the saved gesture operation is not a flick operation after a hold operation, the process advances to step S2205.

The operation controller 203 determines in step S2205 whether or not an end instruction which instructs to end the list display of thumbnail images of respective pages for the target document is accepted. If the operation controller 203 determines that the end instruction is not accepted, the process returns to step S801 (FIG. 22); otherwise, the process advances to step S2206. In this case, this end instruction is issued by, for example, a touch operation on the document list button 2001 shown in FIG. 20.

In step S2206, the display screen configuration unit 206 ends the display operation of the list display screen 2000. Furthermore, display screen configuration unit 206 releases the select state of pages on the list display screen 2000, and discards the thumbnail list buffer. Moreover, the display screen configuration unit 206 returns the display contents of the display unit 111 from the list display screen 2000 to the list display screen 300. After that, the process returns to step S801 (FIG. 21).

As described above, according to this embodiment, during the list display of thumbnail images of documents saved in the information processing apparatus 100, the display screen can be switched to the list display screen of thumbnail images of respective pages included in a specific document by a simple gesture operation. Thus, this enables the user to confirm the contents of the specific document by the simple gesture operation, thereby improving the search efficiency of documents saved in the information processing apparatus 100. Note that the third embodiment can be implemented in combination with the first and second embodiments.

### Other Embodiments

A single apparatus can be configured by combining the aforementioned embodiments. In this case, that apparatus may include the operations described in the respective embodiments as operation modes, and may be automatically switched under arbitrary conditions. Alternatively, that apparatus may be configured to be manually switched in response to a user instruction.

In the description of the above embodiments, the PC or mobile terminal has been exemplified as the information processing apparatus used to practice the present invention. However, the information processing apparatus used to practice the present invention is not limited to this. That is, an MFP, printer, scanner, FAX, digital camera, digital video camera, television, and the like may be used.

In the description of the above embodiments, the flick operation has been exemplified as an operation that the user makes to attain scrolling display. However, the present invention is not limited to the flick operation as a user operation required to attain scrolling display when it is practiced. For example, the present invention may be practiced if the scrolling display is attained by an operation other than the flick operation for the touch panel. That is, if displayed images are scrolled and displayed by a predetermined operation by the user, the present invention can be practiced. In this case, the predetermined operation may include another gesture operation which is made by touching the touch panel or a gesture operation (so-called spatial gesture operation) made without touching the touch panel. As for the display operation of images to be scrolled and displayed, the present invention is not limited to those which are displayed on a display unit including a touch panel, but images may be projected onto an arbitrary screen using an image projection apparatus such as a projector. Then, by making a predetermined gesture operation (spatial gesture operation, etc.) for the projected images, these images may be scrolled and displayed.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-027725, filed Feb. 10, 2012, which is hereby incorporated by reference herein in its entirety.

What is claimed is:

1. An information processing apparatus, which comprises a display unit configured to display a list of thumbnail images corresponding to documents saved in said information processing apparatus, comprising:
a display control unit configured to lay out a plurality of thumbnail images each of which is a thumbnail image of an arbitrary page included in a corresponding document, and to display a list of the plurality of thumbnail images on the display unit;
an accepting unit configured to accept a touch operation for a display area of the display unit on which the list of the plurality of thumbnail images is displayed;
a thumbnail changing unit configured to change, in a case that the touch operation accepted by said accepting unit is a flick operation in a first direction, a thumbnail image displayed on an area for which the flick operation has been made on the display area, of the plurality of thumbnail images, to a thumbnail image of a different page included in a corresponding document; and
a scrolling unit configured to scroll, in a case that the touch operation accepted by said accepting unit is a flick operation in a second direction perpendicular to the first direction, the list of the plurality of thumbnail images displayed on the display area in the second direction.

2. The apparatus according to claim 1, wherein in a case that the flick operation in the first direction is made across areas on which two or more thumbnail images that are laid out at neighboring positions are displayed on the display area, said thumbnail changing unit changes all of the two or more thumbnail images to thumbnail images of different pages included in corresponding documents.

3. The apparatus according to claim 1, wherein said thumbnail changing unit changes a thumbnail image displayed on an area for which the flick operation in the first direction has been made on the display area to a thumbnail image of a next page in a corresponding document.

4. The apparatus according to claim 1, wherein in a case that the touch operation is a flick operation in a direction opposite to the first direction, said thumbnail changing unit further changes a thumbnail image displayed on an area for which the flick operation in the first direction has been made on the display area to a thumbnail image of an immediately preceding page in a corresponding document.

5. The apparatus according to claim 1, wherein the display area includes a plurality of areas on which thumbnail images corresponding to different documents are displayed by said display control unit,
said apparatus further comprises an identification unit configured to identify, of the plurality of areas, an area on which the touch operation accepted by said accepting unit has been made, and
said thumbnail changing unit changes a thumbnail image displayed on the area identified by said identification unit to a thumbnail image of a different page included in a corresponding document.

6. An information processing apparatus, which comprises a display unit configured to display a list of thumbnail images corresponding to documents saved in said information processing apparatus, comprising:
a display control unit configured to lay out a plurality of thumbnail images each of which is a thumbnail image of an arbitrary page included in a corresponding document, and to display a list of the plurality of thumbnail images on the display unit;
an accepting unit configured to accept a touch operation for a display area of the display unit on which the list of the plurality of thumbnail images is displayed;
a thumbnail changing unit configured to change, in a case that the touch operation accepted by said accepting unit is a flick operation for an area on which one thumbnail image is displayed on the display area, the one thumbnail image to a thumbnail image of a different page included in a corresponding document; and
a scrolling unit configured to scroll, in a case that the touch operation accepted by said accepting unit is a flick operation across areas on which two or more thumbnail images that are laid out at neighboring positions are displayed on the display area, the list of the plurality of thumbnail images displayed on the display area in a direction of the flick operation.

7. The apparatus according to claim 6, wherein said thumbnail changing unit changes the one thumbnail image either to a thumbnail image of a next page in a corresponding document or to a thumbnail image of an immediately preceding page in the corresponding document, depending on a direction of the flick operation on the area on which the one thumbnail image is displayed.

8. The apparatus according to claim 6, wherein the display area includes a plurality of areas on which thumbnail images corresponding to different documents are displayed by said display control unit,
said apparatus further comprises an identification unit configured to identify, of the plurality of areas, an area on which the touch operation accepted by said accepting unit has been made,
in a case that an area identified by said identification unit is one area of the plurality of areas, said thumbnail changing unit changes a thumbnail image displayed on the one area to a thumbnail image of a different page included in a corresponding document, and
in a case that areas identified by said identification unit are two or more neighboring areas of the plurality of areas, said scrolling unit scrolls the list of the plurality of thumbnail images displayed on the display area in a direction of the flick operation.

9. The apparatus according to claim 1, further comprising a switching unit configured to temporarily switch, in a case that the touch operation accepted by said accepting unit includes a hold operation for a predetermined time period and a flick operation that follows the hold operation for an area on which one thumbnail image is displayed on the display area, display contents of the display area to a list display of thumbnail images for a plurality of pages included in a document corresponding to the one thumbnail image.

10. The apparatus according to claim 1, wherein said scrolling unit scrolls the list of the plurality of thumbnail images displayed on the display area by moving the list of the plurality of thumbnail images displayed on the display area in a direction of the flick operation, and by newly displaying, on the display area, thumbnail images corresponding to documents which correspond to the number of thumbnail images moved outside the display area and were not selected as list display targets.

11. A method for controlling an information processing apparatus, which comprises a display unit configured to display a list of thumbnail images corresponding to documents saved in said information processing apparatus, comprising:
laying out a plurality of thumbnail images each of which is a thumbnail image of an arbitrary page included in a corresponding document, and displaying a list of the plurality of thumbnail images on the display unit;
accepting a touch operation for a display area of the display unit on which the list of the plurality of thumbnail images is displayed;
changing, in a case that the touch operation accepted in the accepting is a flick operation in a first direction, a thumbnail image displayed on an area for which the flick operation has been made on the display area, of the plurality of thumbnail images, to a thumbnail image of a different page included in a corresponding document; and
scrolling, in a case that the touch operation accepted in the accepting is a flick operation in a second direction perpendicular to the first direction, the list of the plurality of thumbnail images displayed on the display area in the second direction.

12. A method for controlling an information processing apparatus, which comprises a display unit configured to display a list of thumbnail images corresponding to documents saved in said information processing apparatus, comprising:
laying out a plurality of thumbnail images each of which is a thumbnail image of an arbitrary page included in a corresponding document, and displaying a list of the plurality of thumbnail images on the display unit;
accepting a touch operation for a display area of the display unit on which the list of the plurality of thumbnail images are displayed;
changing, in a case that the touch operation accepted in the accepting is a flick operation for an area on which one thumbnail image is displayed on the display area, the one thumbnail image to a thumbnail image of a different page included in a corresponding document; and
scrolling, in a case that the touch operation accepted in the accepting is a flick operation across areas on which two or more thumbnail images that are laid out at neighboring positions are displayed on the display area, the list of the plurality of thumbnail images displayed on the display area in a direction of the flick operation.

13. A non-transitory computer-readable storage medium storing a computer program for causing a computer to execute steps of the method for controlling the information processing apparatus according to claim 11.

14. A non-transitory computer-readable storage medium storing a computer program for causing a computer to execute steps of the method for controlling the information processing apparatus according to claim 12.
